(19) United States
(12) Patent Application Publication
(10) Pub. No.: US 2023/0306391 A1
(43) Pub. Date: Sep. 28, 2023

(54) PROCESSING PAYMENTS USING ELECTRONIC MESSAGES

(71) Applicant: Block, Inc., San Francisco, CA (US)

(72) Inventors: Marcus Medley, Oakland, CA (US); Claudia J. Ng, San Bruno, CA (US); Suegene Park, Lake Zurich, IL (US); Kyle Snavely, Portland, OR (US)

(21) Appl. No.: 17/701,014

(22) Filed: Mar. 22, 2022

(51) Int. Cl. G06Q 20/10; G06Q 20/40; G06Q 20/38; G06Q 30/06

(52) U.S. Cl. CPC G06Q 20/102; G06Q 20/4014; G06Q 20/386; G06Q 30/0601

(57) ABSTRACT

Techniques described herein are directed to, among other things, enabling customers to order items from a merchant and initiate payment for the items via electronic messages sent from customer devices. For instance, when a first network of the merchant is inoperable, or when the merchant is operating at a location where a first network is unavailable, a customer and a merchant may communicate using electronic messages sent over a second network and may request to initiate payment for items via an electronic message sent over the second network.

### TECHNICAL FIELD

Applications, which are downloadable and executable on user devices, enable users to interact with other users. Such applications are provided by service providers and utilize one or more network connections to transmit data among and between user devices to facilitate such interactions.

### BRIEF DESCRIPTION OF THE DRAWINGS

Features of the present disclosure, its nature and various advantages, will be more apparent upon consideration of the following detailed description, taken in conjunction with the accompanying drawings. The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 is an example environment for ordering items and processing payment for the items using electronic messages, such as text messages, according to an embodiment described herein.

FIGS. 2A-E collectively illustrate an example sequence of operations in which a customer uses a customer device to order and pay for items from a merchant using electronic messages, according to an embodiment described herein.

FIGS. 3A-B collectively illustrate an example process for ordering items from a merchant and paying for the items using electronic messages, according to an embodiment described herein.

FIGS. 4A-C collectively illustrate another example process for ordering items from a merchant and paying for the items using electronic messages, according to an embodiment described herein.

FIGS. 5A-B collectively illustrate an example process for processing a financial transaction over a text-based communications platform, according to an embodiment described herein.

FIG. 6 is an example environment with user devices, merchant devices, a payment service, and/or other systems that may be involved in a transaction, such as by utilizing the payment application as configured herein, according to an embodiment described herein.

FIG. 7 is an example environment illustrating usage of the payment application, such as described herein, according to an embodiment described herein.

FIG. 8 is an example of datastore(s) that can be associated with servers of the payment service, according to an embodiment described herein.

FIG. 9 is an example environment wherein the payment service environment of FIG. 6 can be integrated to enable payments at the point-of-sale using assets associated with user accounts in the peer-to-peer environment of FIG. 7, according to an embodiment described herein.

FIG. 10 is an illustrative block diagram illustrating a system for performing techniques described herein, according to an embodiment described herein.

### DETAILED DESCRIPTION

Techniques described herein are directed to, among other things, enabling frictionless commerce between users through electronic communications. For example, the techniques described herein enable customers to order items from a merchant and initiate payment for the items via electronic messages, e.g., text messages, e-mail messages, forum messages, social networking messages, direct messages, voice messages, etc., sent from customer devices. By coordinating conversational text-based messaging between a merchant and customer for orders, the disclosed systems and techniques leverage communication services to facilitate payments in places with limited Internet connectivity or without computer access. In one example, a custom messaging server coordinates conversational messages between merchants and customers, enabling the parties to modify order details and update pricing over text message. Once accepted, the final invoice is passed and charged by the customer cellular account, or alternatively to an account held by the payment service.

In an example, a merchant may maintain an account with a payment service such that the payment service processes payments for respective costs of transactions between the merchant and customers of the merchant. For instance, when a customer orders one or more items from the merchant, the customer or the merchant may utilize a respective computing device to send a request to the payment service to process a payment for the items. For instance, the merchant may use a merchant device or the customer may use a customer device to send a request to initiate payment to the payment service over one or more networks, such as a wireless network of the merchant or the like.

While the payment service often makes payment processing convenient for the customer and the merchant when a network is available, such payment processing is made more difficult when a network is unavailable, such as when a network of the merchant goes offline, when the merchant is located at a location where a network connection is not available, or the like. In these instances, previous techniques may perform “offline transactions”—that is, transactions where the merchant device stores data associated with the payment transaction on the merchant device and then later sends this transaction data to the payment service when a network connection becomes available. For instance, if a network connection is restored or if the merchant device moves to a location where a network connection is available, then the merchant device may send the transaction data to the payment service and may request that the payment service process the payment.

In some instances, however, the merchant may engage in multiple transactions while a network is unavailable and, thus, may send transaction data for these multiple transactions to the payment service when the network connection becomes available. While these offline-transaction techniques enable the merchant to continue engaging in transactions with customers while a network is unavailable, these techniques increase the risk of nonpayment as compared to online transactions—that is, transactions where a network connection is available. As will be appreciated, this increased risk is due to the chance that some of the offline transactions will ultimately be denied when the network connection becomes available. For instance, some of the payment methods (e.g., credit cards, gift cards, etc.) used by the customers while the merchant device operates in the offline mode may be denied when the merchant device is back online and requests that the payment service process a payment.

To this end, present methods and systems enable merchants and customers to engage in transactions when a network connection is unavailable, while securing successful fulfillment of the transactions.

In an example, techniques described herein enable customer devices and merchant devices to interact with one another and to process payments with the payment service using electronic messages sent between customer and merchant devices. In this example, for instance, the customers and merchants may interact through text messages, which may comprise any sort of message sent between devices in which the message is manually input via a keyboard, voice recognition, or the like. For instance, using the techniques described herein, the example merchant may utilize a computing device that resides remotely from or is physically present at a location of the merchant, with this computing device being configured to receive communications over a cellular network that remains available even when a wireless network of the merchant (e.g., a WiFi network) is down. Further, the computing device of the merchant may be associated with an identifier, such as a phone number of a short messaging service (SMS) short code, such that the computing device is configured to receive text messages over the cellular network.

Having this computing device, the merchant may then instruct customers at the merchant location to interact with the merchant by sending text messages to the identifier associated with the computing device. For instance, the merchant location may include signage instructing customers to send a text message to this identifier associated with the computing device or may otherwise inform the customers. For instance, a customer that enters a location of the merchant may see a sign instructing the customer to send a text message to the identifier, which may be received at the computing device. The computing device may receive the text message that includes the identifier. In some instances, the computing device may be dedicated to the merchant, while in other instances the computing device may be associated with multiple identifiers that are each associated with a respective merchant. In these instances, the computing device may receive the text message from the customer device, identify the merchant from the identifier specified in the message, and determine the corresponding merchant account.

After identifying the merchant account, or after receiving the initial text message at a merchant device associated with a single merchant, the computing device may send a text message back to an identifier (e.g., phone number or SMS short code) associated with the customer device. In some instances, this text message may comprise a listing (e.g., menu, catalog, etc.) of items available for acquisition (e.g., purchase, rent, lease, etc.) at the merchant. In some instances, the text message may include or point to a resource (such as an app clip, instant application, progressive web application, website, etc.) such as an ecommerce platform customized to the customer. In addition, the text message may include instructions regarding how to order items. For instance, if the merchant is a restaurant, the text message may include an instruction to text back “1” to order a first menu item, “2” to order a second menu item, and so forth. In some instances, in some instances the text message may additionally or alternatively include a link to a webpage or application association of the merchant that lists the menu, instructions, and the like.

In response, the customer may operate the customer device to send an order for one or more items to the merchant device. For instance, if the customer wishes to order the first menu item (e.g., a hamburger) and the second menu item (e.g., French fries) then the customer may send a text message to the computing device specifying the identifier of the computing device and including the text “1” and “2”. In some cases, a customer's natural language instructions can be parsed to detect intent and accordingly select items (similar items) and place order for the selected items. Upon receiving the text message from the customer device, the computing device may update order data stored in association with the identifier (e.g., phone number or SMS short code) associated with the customer device and, in addition, may send a text message to an identifier (e.g., phone number or SMS short code) associated with a merchant device. For instance, this text message may indicate the item(s) ordered by the customer and potentially additional information associated with the customer (e.g., the table they are seated at, etc.). The text message can be sent directly to a kitchen display system that may then initiate preparation of the ordered items. In addition, the computing device can send a text message to the identifier associated with the customer device indicating that the merchant has begun preparation of the order.

In some instances, upon the computing device receiving the order for the item(s) from the customer device, the computing device may access a merchant account at the computing device to determine a merchant device (or multiple merchant devices) to which to send a text message to. For instance, if a first employee of the merchant works at the merchant location during a first time range, then a phone number or SMS short code associated with a merchant device of the first employee may be associated with the merchant account during the first time range. In addition, a second employee of the merchant may work at the merchant location during a second time range, and the computing device may send text messages to a phone number or SMS short code associated with a merchant device of the second employee during the second time range. In some instances, the employees may send respective messages to the computing device to associate their respective merchant devices during the time ranges, while in other instances the computing device may store schedule data indicating when the respective employees work and, thus, when to associate the respective merchant devices with the merchant account. In addition, or in the alternative, upon the computing device receiving the order for the item(s) from the customer device, the computing device may determine which merchant device(s) to send the order or other message to based on the current load on each of multiple merchant devices. For instance, the computing device may act as a load balancer to spread out the incoming text messages amongst multiple merchant devices.

Regardless of which particular merchant device is currently associated with the merchant account, it is to be appreciated that routing text messages between a customer and the merchant through the computing device enables the phone numbers or SMS short codes associated with the customer device and the merchant device to remain unknown to each party. That is, when the customer device sends a text message to the identifier associated with the computing device, and the computing device in response sends a text message to the merchant device, the text message to the merchant device may be free from the identifier (e.g., phone number, SMS short code, etc.) associated with the customer device. In addition, when the merchant device sends a text message to the computing device, which in turns sends a text message to the customer device, this latter text message from the computing device may be free from the identifier (e.g., phone number, SMS short code, etc.) associated with the merchant device. Thus, the customer is unaware of the identifier associated with the merchant device, while the merchant is similarly unaware of the identifier associated with the customer device.

Returning to the example above, after the merchant has prepared and provided the items to the customer, the customer device and/or the merchant device may request that payment for the item(s) be initiated by sending a text message to the computing device. For instance, the customer device may send a text message that includes a particular command (e.g., “pay”, a predefined phrase or number, etc.) to the identifier associated with the computing device. Alternatively, the merchant device may send this text message to initiate payment to the identifier of the computing device. In either instance, upon receiving this text message the computing device may identify the identifier of the device that sent the request to identify the correct order data and may initiate payment processing. This may include sending a request to a mobile-carrier service associated with the customer device of the customer. For instance, if the total cost of the order was $45.50, the computing device may send a request to the mobile-service carrier to charge a phone bill of the customer for this amount of money.

Upon receiving this request, the payment service can piggyback on the mobile-carrier service to add this cost to the phone bill. In addition, the computing device may, at the same or a later time, send an indication to a payment service indicating the request that was sent to the mobile-carrier service. Therefore, the payment service may, at that time or a later time, send a request to the mobile-carrier service to transfer some of all of the funds (e.g., $45.50) to a merchant account associated with the merchant. Therefore, while the customer will pay for the cost of the order to the mobile-service carrier (on the phone bill of the customer), the mobile-service carrier may send funds equal to or slightly less than the total cost to the merchant.

As will be appreciated, by enabling the customer device and the merchant device to conduct transactions via text messaging, these customers are able to conduct business with one another even when a local area network (LAN) or wide area network (WAN) is unavailable, either because the network is down or because the merchant is located at a location that does not have adequate network service. Further, because the text messages can be sent between the customer device and merchant device, as well as between the computing device and the mobile-carrier service, in real-time or near-real-time, the merchant can receive an indication in real-time or near-real-time whether a payment was successful. For instance, if the mobile-carrier service is able to add the cost of the items to the phone bill of the customer, then the mobile-carrier service may send a confirmation to the computing device, which can communicate this (e.g., via text message) to the merchant device. If the mobile-carrier service is unable to process this payment, then the merchant may request that the customer provide an alternative form of payment. Thus, these computer- and network-centric techniques enable payment even in the absence of a LAN or WAN network, while enabling a merchant to determine in real-time or near-real time whether a payment has been successful.

While the above introduction and the below examples describe using electronic messages, such as text messages, to enable merchant and customer devices to engage in the transactions described above and below, in some instances the techniques may enable other types of processes using text messages. For instance, an example merchant may use a merchant device to send text messages to the payment service to onboard the merchant in some instances. For instance, the merchant device may send a text message to the payment service to request to set up an account with the payment service. The merchant device and the payment service may then engage in a back-and-forth communication via text messages to complete the onboarding process of the merchant.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

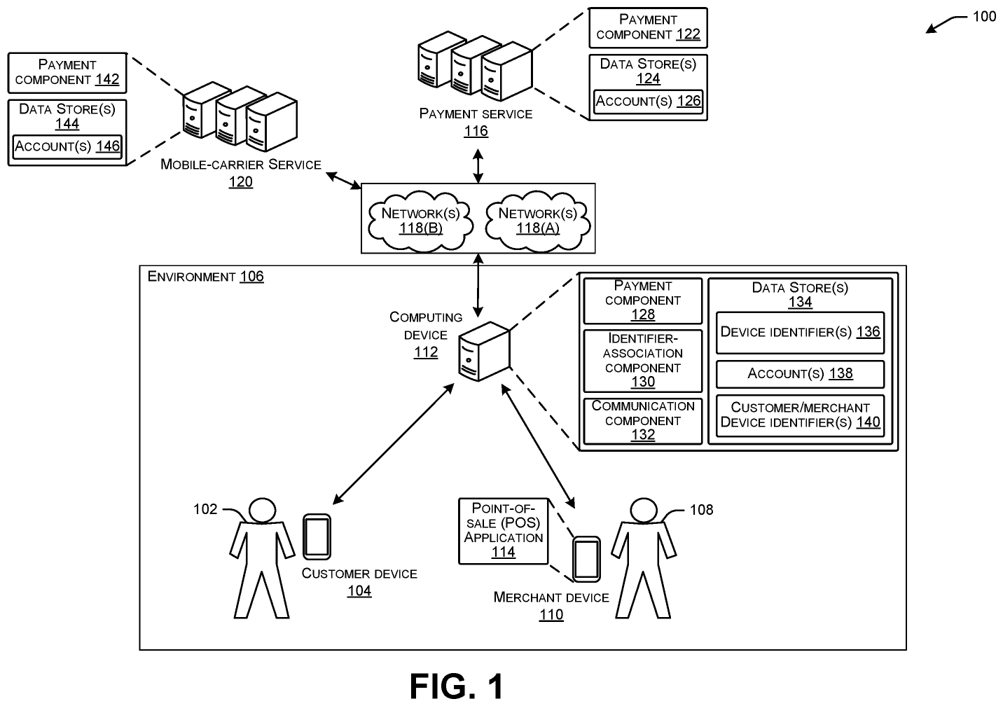

FIG. 1 is an example environment 100 that enables customers to order items from a merchant and initiate payment for the items via electronic messages, such as text messages, sent from customer devices. As will be discussed below, merchant devices may also send electronic messages, such as text messages, to initiate payment in some instances.

As illustrated, the environment 100 includes an example customer 102 operating a customer device 104 in an environment 106 associated with a merchant 108. While a single customer 102, merchant 108, and merchant environment 106 is illustrated, it is to be appreciated that the techniques described herein may apply equally to multiple customers, merchants, and merchant environments. As illustrated, the merchant may also be associated with a merchant device 110. The merchant device 110 may comprise a mobile phone, a tablet, a server computing device, a laptop, or any other type of computing device. In general, the customer 102 and the merchant may communicate, in whole or in part via communications between the customer device and the merchant device, as routed through a computing device 106 within or otherwise associated with the merchant location 106, as described in detail below.

In some instances, the merchant device may include one or more hardware processors and computer-readable media storing a point-of-sale (POS) application enables the merchant to conduct transactions with customers, such as the customer 102. For instance, as the customer 102 orders item(s) from the merchant 108, the merchant 108 may input data corresponding to the order into the POS application 114. In addition, when the customer is ready to pay for the items, the POS application may couple to a payment service 116 over one or more networks 118(A) (e.g., local area network(s) (LANs), wide area network(s) (WANs), etc.) in order to process payment for the item(s). For instance, the merchant 108 may receive a payment instrument (e.g., credit card, debit card, gift card, etc.) from the customer 102, input information associated with the payment instrument to the POS application (e.g., via tap, swipe, dip, manual entry, contactless entry, etc.), and send information regarding the payment instrument, details associated with the transaction with the customer 102, and a request to process the payment the payment service 116. The payment service, upon receiving the request, may attempt to authorize the transaction using the payment-instrument information and may send an indication regarding whether the transaction was successfully processed to the POS application 114 operating on the merchant device 110.

In some instances, however, the merchant device 110 may lack access to the networks 118(A) because the network(s) are offline, because the merchant environment 106 is located in a remote location, or the like. In these instances, the merchant device 110, the customer device 104, or both may interact with a computing device 112 that is located at or otherwise associated with the merchant location 106 and that is able to access one or more different networks 118(B) for initiating the processing of payments for transactions between the example customer 102 and the example merchant 108. For instance, the computing device 112 may be configured to initiate payment for a transaction over a cellular network in response to receiving a message (e.g., SMS text message, MMS text message, etc.) from the customer device 104 or the merchant device 110. For instance, if the networks 118(A) are unavailable to the POS application 114, then the merchant 108 or the customer 102 may utilize the computing device 112 to initiate payment processing for a transaction between the merchant 108 and the customer 102 by sending a request, a to a mobile-carrier service 120 associated with the customer device 104, to charge an account of the customer at the mobile-carrier service for a cost of the transaction. In response to receiving a request to do so, the mobile-carrier service 120 may charge a corresponding cost to an account of the customer 102 at the mobile-service carrier 120 and, in some instances, may automatically transfer some of these funds to a merchant account of the merchant 108 at the payment service 116. In other instances, meanwhile, the computing device 112 may send, to the payment service 116, an indication associated with the charging of the user account at mobile-carrier service 120 for the cost of the transaction. In response, the payment service 116 may send a request to the mobile-service carrier 120 to send some or all of the funds associated with the transaction to a merchant account associated with the merchant 108 at the payment service 116 or to a merchant account maintained a financial institutions.

The payment service 116 may include one or more hardware processors and computer-readable media storing, in part, a payment component 122 and one or more datastores 124, which may store an array of accounts 126 that include merchant accounts, customer accounts, and the like. The payment component 122 may function to initiate payment processing in response to receiving a request to do so from the POS application 114. In addition, upon receiving an indication from the computing device 112 (or the mobile-carrier service 120) that the mobile-carrier service 120 settled the payment, the payment component 122 may work with the mobile-carrier service 102 to ensure that funds equal to slightly less than the cost of the transaction is routed to a merchant account at the payment service 116 or at a financial institution.

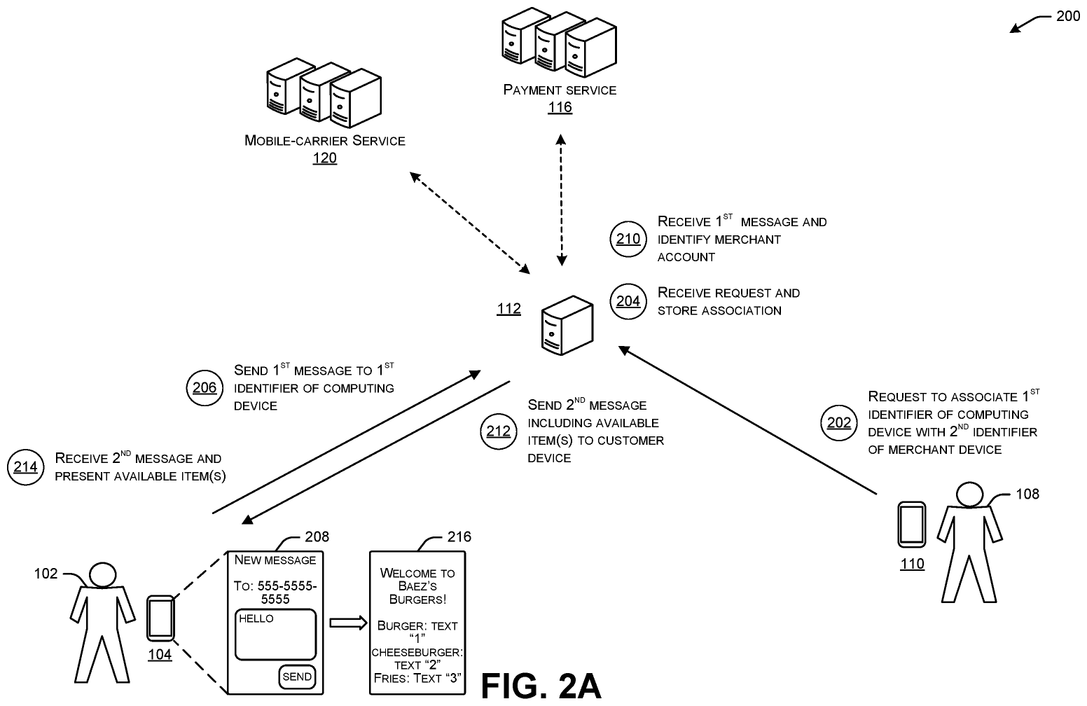

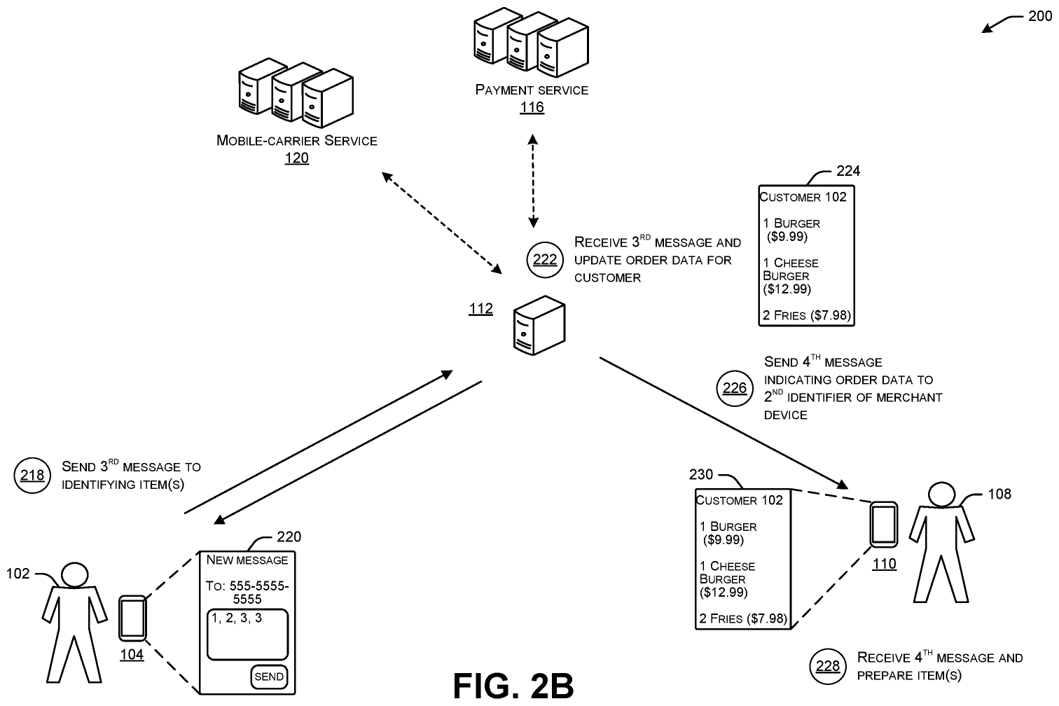

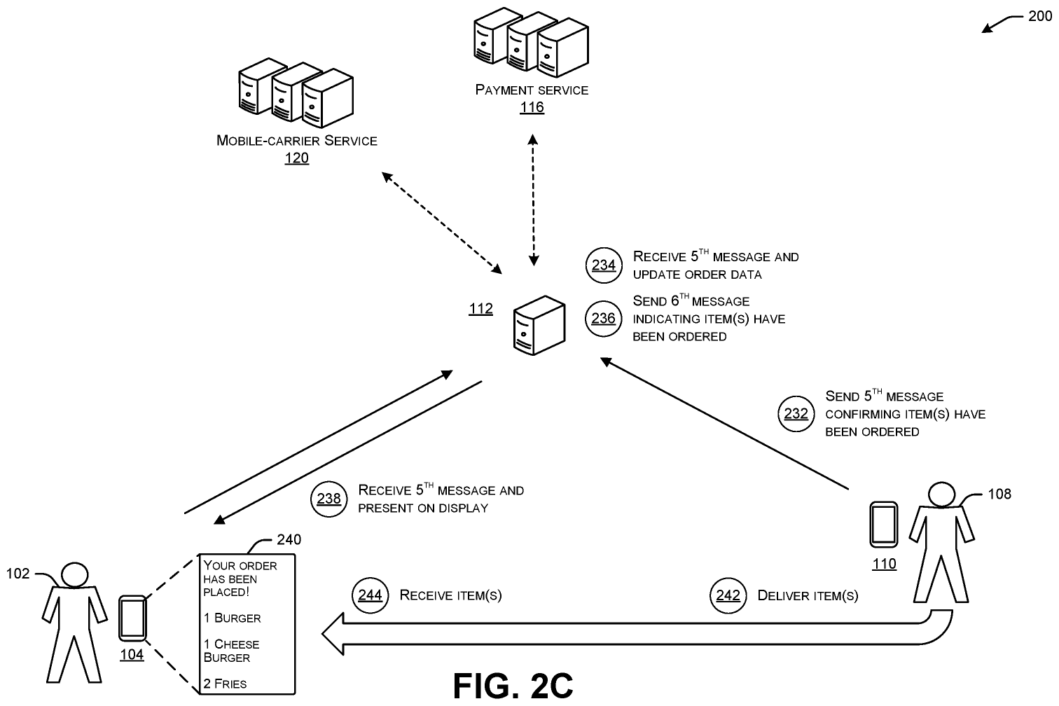

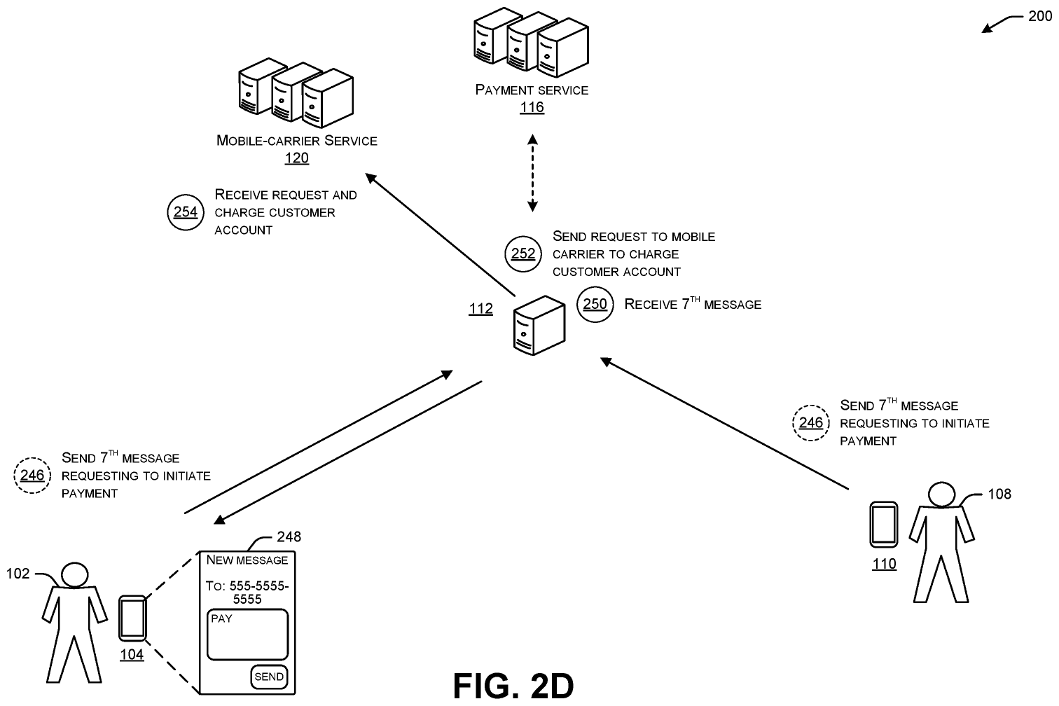

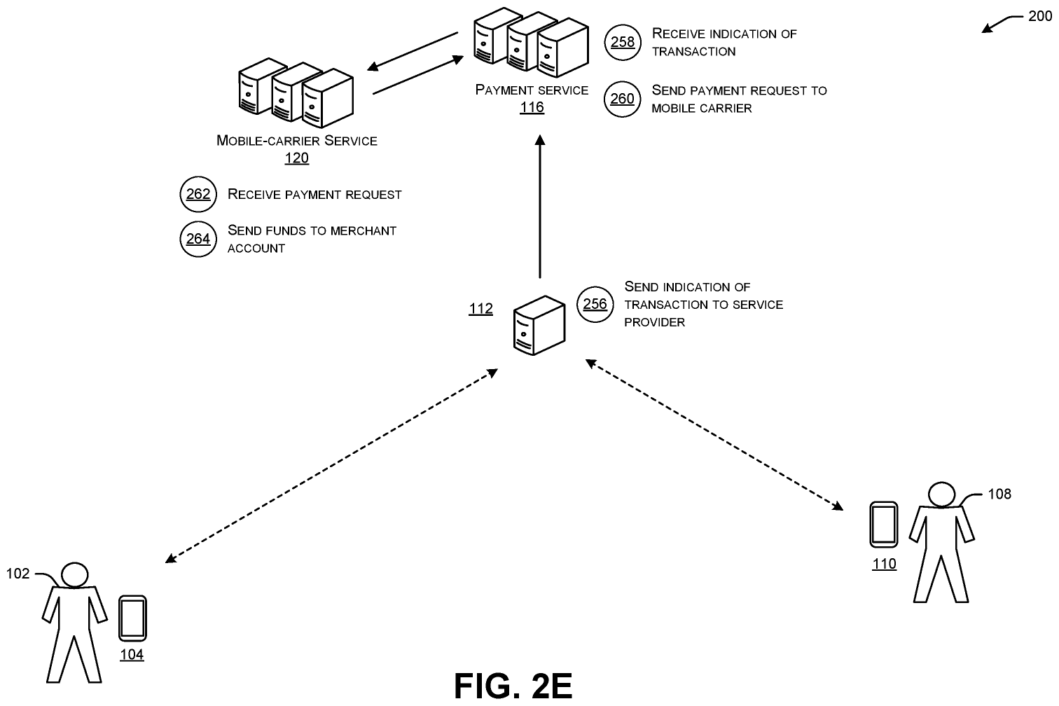

The computing device 112 may include one or more hardware processors and computer-readable media that stores a payment component 128, an identifier-association component 130, a communication component 132, and one or more data stores 134. The data stores 134 may store one or more device identifiers associated with the computing device, one or more accounts 138 (e.g., one or more merchant accounts), and one or more identifiers 140 associated with customer and/or merchant devices. The payment component 128 may function to receive a request from the customer device 104 or the merchant device 110 (e.g., via a text message) and send, over the networks 118(B), a request to process payment for a transaction to the mobile-carrier service 120. FIGS. 2A-E discuss an example sequence of operations for initiating this payment request and are discussed in further detail below.

The identifier-association component 130, meanwhile, may function to store respective associations between a device identifier 136 associated with the computing device and a device identifier associated with the customer device 104 or the merchant device 110. For instance, prior to engaging in a transaction with the customer 102, the merchant 108 may initially use the merchant device 110 to indicate that a particular identifier associated with the merchant device 110 is to be associated with the computing device 112, such that when the computing device 112 receives electronic messages (e.g., text messages) directed to the device identifier 136 associated with the computing device 112, the computing device 112 routes these messages to the identifier associated with the merchant device 110. For instance, the merchant 108 may indicate a mobile phone number or SMS short code associated with the merchant device 110, such that when the customer 102 or another customer sends a message to a phone number or SMS short code associated with the computing device 112, the computing device 112 sends a corresponding message to the merchant device 110. Similarly, the identifier-association component 130 may store an association between an identifier (e.g., mobile phone number, SMS short code, etc.) of the customer device 104 and an order initiated by the customer device 104 such that when the merchant device 110 sends a message regarding the order to the computing device 112, the computing device 112 routes a corresponding message to the identifier associated with the customer device. While the identifier-association component 130 may store the respective associations between the device identifiers, the communication component 132 may responsible for receiving communications (e.g., text messages) from the customer and merchant devices and sending corresponding messages to these devices.

In this way, the customer device 104 can communicate with the merchant device 110, but through the computing device 112 rather than directly. As will be appreciated, this allows the customer and merchant devices to communication with one another while refraining from enabling the customer 102 to know the identifier associated with the merchant device 110 and without enabling the merchant 108 to know the identifier associated with the customer device 104. Further, by providing the computing device 112 as a third-party intermediary, the techniques enable different merchant-device identifiers to be associated with the computing device 112 at different times. For instance, while the above example describes the merchant 108 as associating the identifier of the merchant device 110 with the computing device 112, at another time a different user associated with the merchant environment 106 (e.g., a different employee at the merchant) may associate a different merchant-device identifier with the computing device 112. By doing so, different devices may receive the communications from the communication component depending on which users (e.g., employees) are currently located at the merchant environment 106.

FIGS. 2A-2E collectively illustrate an example environment and sequence of operations 200 with reference to the architecture introduced in FIG. 1. At an operation 202, the example merchant 108 may operate the merchant device 110 to send, to the computing device 112, a request to associate a first identifier associated with the computing device 112 with a second identifier associated with the merchant device 110. Upon receiving this request at an operation 204, the identifier-association component 130 may store, in an account 138 associated with the merchant 108, an indication that the identifier 136 associated with the computing device 112 is associated with the received identifier 140 associated with the merchant device, such that the communication component 132 is to send messages directed to the first identifier of the computing device 112 to the second identifier associated with the merchant device 110. For instance, this association may indicate that upon receiving a message to a mobile phone number associated with the computing device 112, the communication component 132 is to route a corresponding message to a mobile phone number associated with the merchant device 110. In some instances, the merchant may make this request via a message (e.g., a text message), by accessing a webpage associated with the computing device 112, or in any other manner.

Sometime after the second identifier of the merchant device 110 has been associated with the first identifier of the computing device 112, the customer 102 may operate the customer device 104 to send, at an operation 206, a first message to the first identifier associated with the computing device 112. For instance, the merchant 108 may instruct (orally, via signage, or in any other manner) the customer 104 to send the first message to particular phone number or SMS short code associated with the computing device 112 in order to initiate an order with the merchant 108. FIG. 2, for instance, illustrates that the customer 102 uses the customer device 104 to send a first message 208 to a specified example phone number (555-555-5555) with a predefined command (“hello”). Again, the merchant 108 may specify this command or, in some instances, the customer 102 may any command or string to this phone number.

At an operation 210, the computing device 112 receives the first message and, using the first identifier (here, the phone number), identifies the merchant account 138 associated with the merchant 108. It is to be appreciated that, in some instances, the computing device 112 may be associated with and used by multiple merchants, where each merchant account 138 is associated with a unique identifier (e.g., phone number, SMS short code, etc.). Upon identifying the merchant account associated with the merchant 108, the computing device 112 may, in this example, acquire initial data from the merchant account 138 to send back to the customer device 104 that sent the first message. For instance, the computing device 112 may determine, from the merchant account, that particular data is to be sent back to customer devices that text the computing device, such as a welcome message, a menu of items available at the merchant 108, and the like. In this example, the computing device 112 generates and sends, at an operation 212, a second message that indicates a menu of available items at the merchant 108 back to the customer device. In this example, the message 216 comprises a text message that indicates the available items and instructions regarding how to order the items via a subsequent message. For example, this message 216 states: “Welcome to Baez's Burgers! Burger: text “1” Cheeseburger: text “2” Fries: text “3”.” While this example indicates that the message 216 directly includes the menu and the instructions for ordering one or more items, it is to be appreciated that in other instances the second message may include a hyperlink to the menu, a request to download a mobile application associated with the merchant 108, and so forth.

FIG. 2B continues the illustration of the sequence of operations and includes, at an operation 218, the customer 102 using the customer device 104 to send a third message 220 to the first identifier associated with the computing device 112, with the third message 220 specifying one or more items that the customer 102 would like to order. Here, for instance, the example message 220 includes the text: “1, 2, 3, 3”, indicating that the customer 102 would like to order one hamburger, one cheeseburger, and two orders of fries. The computing device 112 may receive the third message at an operation 222 and may update order data associated with the customer 102. That is, the computing device 112 may store the order data in account 138 created for the customer 102. Here, for instance, the computing device 112 has generated an order 224 for the customer 102 indicating the requested items and their respective costs.

At an operation 226, the computing device 112 may send a fourth message indicating the order data to the second identifier associated with the merchant device 110. That is, given that the merchant 108 has previously requested to associate the first identifier associated with the computing device with the second identifier associated with the merchant device, the communication component 132 of the computing device 112 may send this fourth message including the order data to the merchant device 110. At an operation 228, the merchant device 110 receives the fourth message and the merchant 108 may begin to prepare the items. In this example, the fourth message 230 may comprise the order details associated with the order of the customer 102.

FIG. 2C continues the illustration of the sequence of operations 200 and includes, at an operation 232, the merchant 108 using the merchant device 110 to send a fifth message to the first identifier of the computing device 112 indicating that the merchant 108 has received the order. At an operation 234, the computing device 112 receives the fifth message and, at an operation 236, the communication component 132 sends a sixth message to the customer device 104 indicating that the items have been ordered. At an operation 238, the customer device 104 receives the sixth message 240, which may indicate that the order of the customer 102 has been successfully placed with the merchant 108. At an operation 242, the merchant may deliver the items to the customer 102, who may receive the ordered items at an operation 244.

FIG. 2D continues the illustration of the sequence of operations 200 and includes, at an operation 246, the customer device 104 or the merchant device 110 sending a seventh message to the first identifier associated with the computing device 112 requesting to initiate payment processing for the order of the customer 102. For instance, the customer 102 may use the customer device 102 to send a message to initiate the payment, or may request that the merchant 108 use the merchant device 110 to send the message to initiate the payment. In one example, the customer 102 uses the customer device 104 to send a seventh message 248 including the command “pay” to cause the computing device 112 to initiate payment.

At an operation 250, the computing device receives the seventh message, recognizes the command, and causes the payment component 128 to initiate payment processing. At an operation 252, for instance, the computing device 112 may send, over the networks 118(B), a request to the mobile-carrier service 120 associated with the customer device 104 to charge an account of the customer 102 for the total cost of the transaction with the merchant. For instance, this request may specify the identifier (e.g., phone number) associated with the customer device 104, a cost of the transaction, details of the transaction (e.g., merchant name, etc.), and a request to charge the account for the cost. At an operation 254, the mobile-carrier service 120 may receive the request and may charge the customer account for the cost of the transaction by, for instance, adding the cost to a mobile-phone bill associated with the customer 102.

FIG. 2E concludes the illustration of the sequence of operations and includes, at an operation 256, the computing device 256 sending, over the networks 118(B) or 118(A) (if available), an indication of the transaction to the payment service 116. For instance, this indication may include details of the transaction, such as an identifier of the customer or customer device, an identifier of the merchant or merchant device, a cost of the transaction, an indication that the customer account of the customer 102 at the mobile-carrier service 120 has been charged for the transaction, and so forth. At an operation 258, the payment service 116 receives the indication of the transaction and, at an operation 260, sends a payment request to the mobile-carrier service 120. For instance, the payment service 116 may send a request to the mobile-carrier service 120 indicating the transaction and the customer, and requesting that the mobile-carrier service 120 send some or all of the funds associated with the transaction an account of the merchant at the payment service 116 or at a financial institution.

At an operation 262, the mobile-carrier service may receive the payment request and, at an operation 264, may send funds to the merchant. Thus, while the customer 102 may ultimately pay the mobile-carrier service 120 for the cost of the transaction, given that it is has been added to the phone bill of the customer 102, the mobile-carrier service 120 may reimburse the merchant 108 for some or all of this amount.

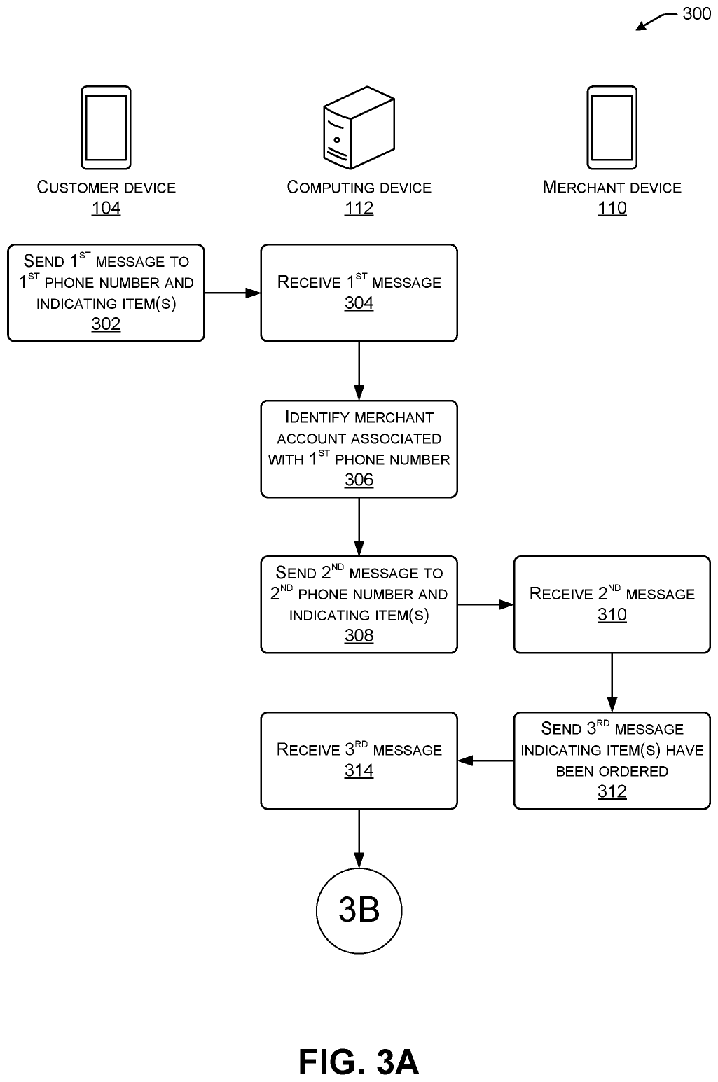

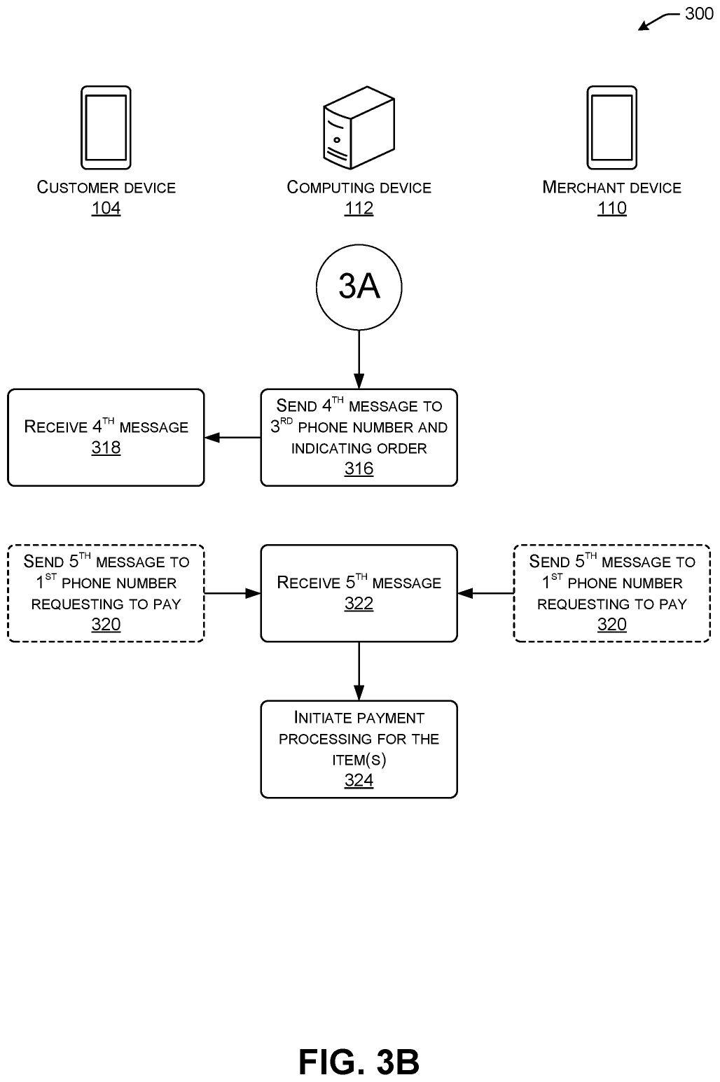

FIGS. 3A-B and 4A-C are example processes for enabling payment via electronic messages, such as text messages. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At an operation 302, the customer device 104 may send a first message to a first phone number associated with the computing device 112 associated with the payment service 116, with the first message specifying one or more items. For instance, the customer 102 may use the customer device 104 to send a text message for ordering the items from an inventory of items offered by a merchant. In some instances, the merchant device 110 or the computing device 110 may have previously sent an electronic message (e.g., text message) to the customer device 104 specifying an inventory of available items offered by the merchant. At an operation 304, the computing device 112 receives, from the customer device, the first message (i) specifying a first recipient phone number associated with the computing device 112, and (ii) including the order for one or more items offered by a merchant, such as the merchant 108.

At an operation 306, the computing device identifies a merchant account associated with the first phone number. For instance, the computing device 112 may parse the first message to identify the contact information specified by the message and may determine a merchant account corresponding to that contact information. At an operation 308, the computing device sends a second message to the merchant device 110 associated with the merchant account, with the second message (i) specifying a second recipient phone number associated with the merchant device, and (ii) including the order for the one or more items.

At an operation 310, the merchant device 110 receives the second message. In response, a merchant may begin processing the order, such as acquiring the items, preparing the items, or the like. For instance, the merchant may place an order for the items in a system associated with the merchant and, at an operation 312, may send a third message (i) specifying the first recipient phone number, and (ii) including an indication that the one or more items have been ordered. At an operation 314, the computing device 112 receives the third message.

FIG. 3B continues the illustration of the process 300 and includes, at an operation 316, sending a fourth message from the computing device 112 to the customer device 104, the fourth message (i) specifying a third recipient phone number associated with the customer device 104, and (ii) including the indication. For instance, the fourth message may indicate that the items have been ordered. At an operation 318, the customer device 104 receives the fourth message. In response, the customer device 104 may present a UI corresponding to the fourth message, indicating to the customer that the items have been ordered.

At an operation 320, one of the customer device 104 or the merchant device 104 sends, to the computing device, a fifth message (i) specifying the first recipient phone number, and (ii) including a request to process a payment for the one or more items. For instance, the customer or the merchant may send a text message to the contact information (e.g., phone number or SMS short code) associated with the computing device requesting to finalize a transaction for the ordered items. At an operation 322, the computing device 112 receives the fifth message and, at an operation 324, initiates payment processing for the one or more items at least partly in response to receiving the fifth message. In some instances, initiating payment processing comprises sending a request to a mobile carrier associated with the customer device 102 to charge an account associated with the customer device at the mobile carrier for a cost of the one or more items. Further, in some instances, a second computing device associated with the payment service 116 may send a request to the mobile carrier to send funds for at least a portion of the cost of the one or more items to a financial account associated with the merchant, as described above. Further, in some instances, initiating payment may include sending a message to the customer device 104 comprising a request to authorize the payment. Upon the customer using the customer device 104 to send a confirmation that the payment is authorized to the computing device 112, the computing device 112 may send the request to the mobile carrier to charge the account of the user.

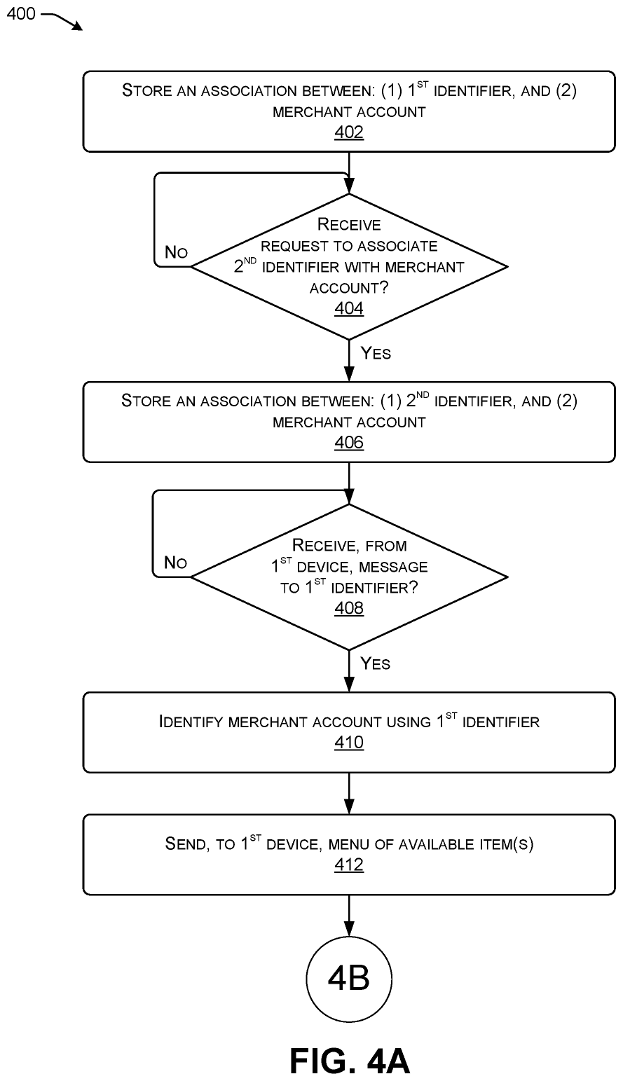

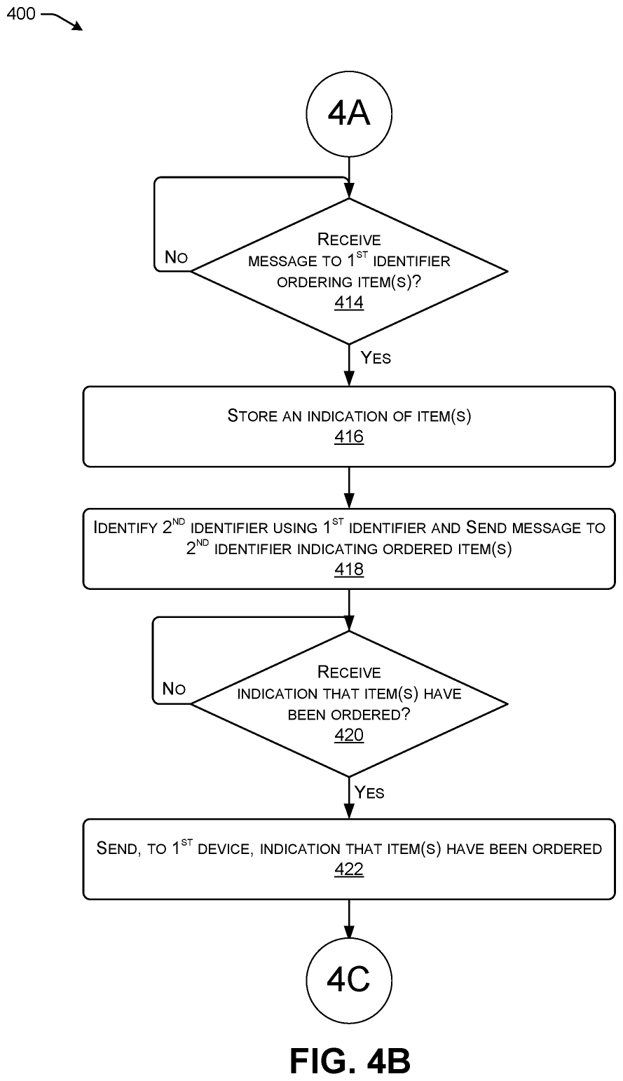

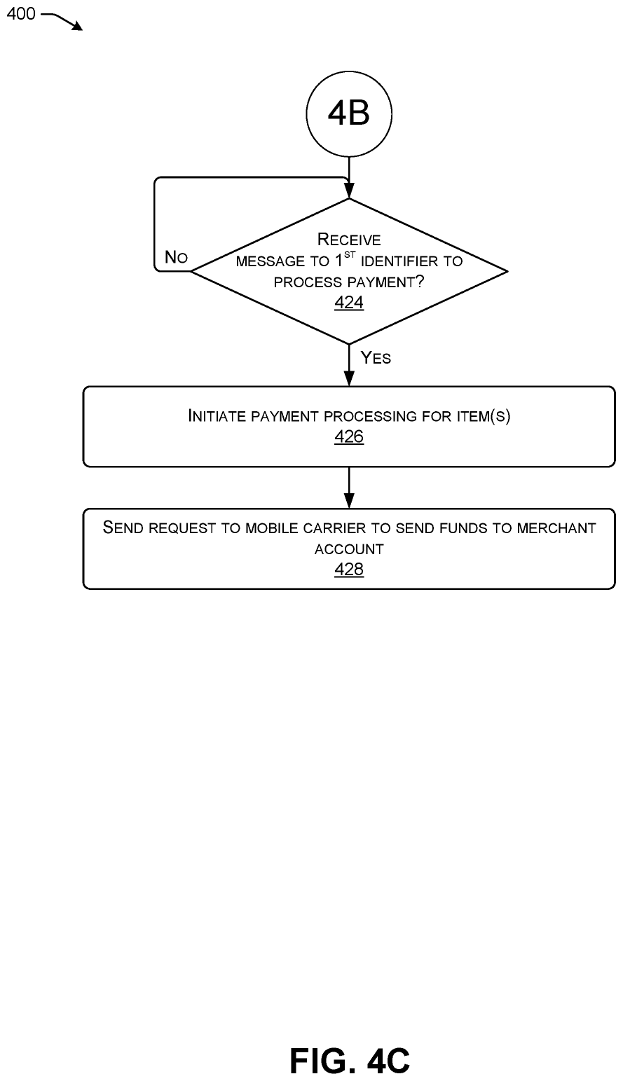

FIGS. 4A-C collectively illustrate another example process 400 for ordering items from a merchant and paying for the items using electronic messages, such as text messages, according to an embodiment described herein. At an operation 402, the computing device 112 described above may store an association between: (i) a first identifier associated with the computing device (e.g., a first phone number or a first SMS short code), and (ii) an account of the merchant 108. For instance, this operation may represent storing an association between a phone number (e.g., 555-555-5555) of the computing device 112 and a merchant account maintained at the computing device 112. At an operation 404, the computing device may determine whether a request to associated a second identifier associated with a merchant device of the merchant has been received. For instance, this operation may comprise determining whether a request to associate a phone number of a merchant device has been received. If so, then at an operation 406 the computing device may store an association between: (i) the second identifier associated with the merchant device, and (ii) the account of the merchant. As described above, this may enable text messages sent to the computing device to now be routed to the merchant device associated with the second identifier.

At an operation 408, the computing device 112 determines whether a message from directed to the first identifier (of the computing device 112) has been received from a first device, such as the customer device 104. If so, then at an operation 410 the computing device 112 identifies, at least partly in response to receiving the first message directed to the first identifier, the account of the merchant and, at an operation 412, sends, to the first device, a menu of available items at the merchant.

FIG. 4B continues the illustration of the process 400 and includes, at an operation 414, the computing device 112 determining whether a message directed to the first identifier and ordering one or more items has been received. If so, then at an operation 416 the computing device 112 stores an indication of the items as order data at the computing device 112. In addition, at an operation 418, the computing device uses the first identifier to identify the second identifier and sends a message to the device associated with the second identifier indicating that the items have been ordered.

At an operation 420, the computing device determines whether an indication that the items have been ordered has been received. That is, this operation may comprise determining whether a confirmation that the items have been ordered has been received from the merchant device. If so, then at an operation 422, the computing device 122 may send, to the first device, an indication that the items have been ordered. For instance, the computing device may send a message to the customer device indicating that the items ordered by the customer have been successfully ordered with the merchant.

FIG. 4C concludes the illustration of the process 400 and includes, at an operation 424, the computing device determining whether a message requesting to process payment for the items has been received from at the first identifier. That is, this operation may comprise determining whether the customer device or the merchant device has sent a message to the computing device 112 requesting to initiate payment processing for the items ordered by the customer. If so, then an operation 426 represents the computing device initiating payment processing for the items. As described above, this may include sending a request to a mobile carrier associated with the customer device to charge an account associated with the customer device at the mobile carrier for a cost of the one or more items. Finally, an operation 428 may comprise sending a request to the mobile carrier to send funds for at least a portion of the cost of the one or more items to a financial account associated with the merchant.

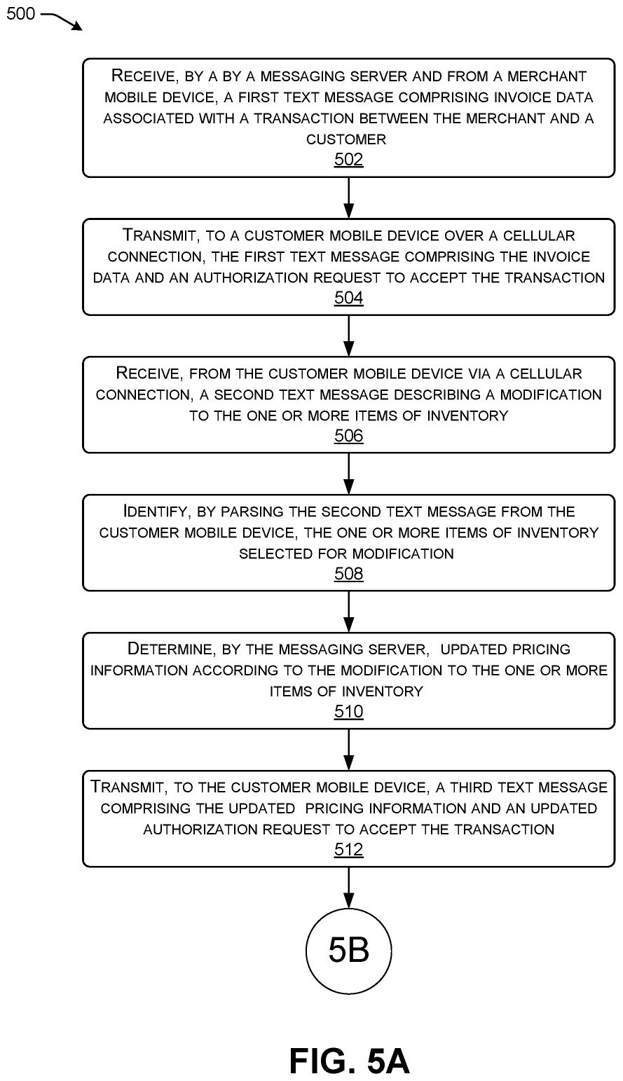

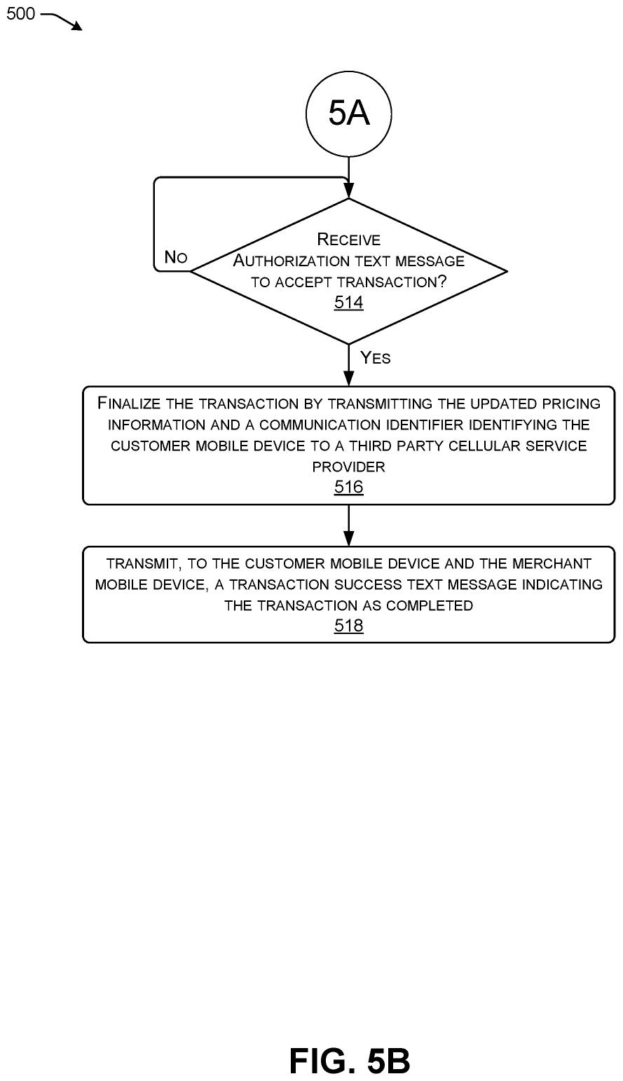

FIGS. 5A-B collectively illustrate an example process 500 for processing a financial transaction over a text-based communications platform. In some instances, the computing device 112 may perform some or all of the operations of the process 500.

An operation 502 represents receiving, by a by a messaging server and via an instance of a messaging application executing on a merchant mobile device, a first text message comprising invoice data associated with a transaction between the merchant and a customer, the invoice data listing one or more items of inventory and associated pricing. In some instances, the messaging server may comprise the computing device 112 and the merchant device may comprise the merchant device 110. In this example, the merchant 108 may operate the merchant device 110 to send, to the computing device 112, a first text message comprising items that a customer, such as the customer 102, has requested to acquire from the merchant 108.

An operation 504 represents transmitting, to a customer mobile device over a cellular connection, the first text message comprising the invoice data and an authorization request to accept the transaction. For instance, the computing device 112 may send the first text message and the authorization request to the customer device 104 associated with the customer 102 such that the customer 102 may determine whether or not to approve the transaction for the listed items.

An operation 506 represents receiving, from the customer mobile device via a cellular connection, a second text message describing a modification to the one or more items of inventory. For instance, the customer may send a text message adding, removing or changing an item listed in the first text message and the computing device 112 may receive this second text message. An operation 508 represents identifying, by parsing the second text message from the customer mobile device, the one or more items of inventory selected for modification. For instance, the computing device 112 may parse the text message to identify the items selected for modification, such as by identifying which items the customer 102 has requested to add, remove, change, or the like.

An operation 510 represents determining, by the messaging server, updated pricing information according to the modification to the one or more items of inventory, while an operation 512 represents transmitting, to the customer mobile device, a third text message comprising the updated pricing information and an updated authorization request to accept the transaction. For instance, the computing device 112 may update the transaction and send the third text message to the customer device 104.

FIG. 5B continues the illustration of the process 500 and includes an operation 514, which represents determining whether the messaging service has received, from the customer mobile device, an authorization text message to accept the transaction. If not, the messaging server awaits an indication or, in some instances, cancels the transaction if an authorization text message is not received within a threshold amount of time or if a denial text message is received. Upon receiving an authorization text message, an operation 516 represents finalizing the transaction by transmitting the updated pricing information and a communication identifier identifying the customer mobile device to a third party cellular service provider, causing an account associated with the communication identifier to be charged according to the updated pricing information. In addition, an operation 518 represents transmitting, to the customer mobile device and the merchant mobile device, a transaction success text message indicating the transaction as completed. For instance, the computing device 112 may transmit the transaction details and the communication identifier to the third party cellular service provider, and may transmit the completion confirmation to the customer device 104 and the merchant device 110.

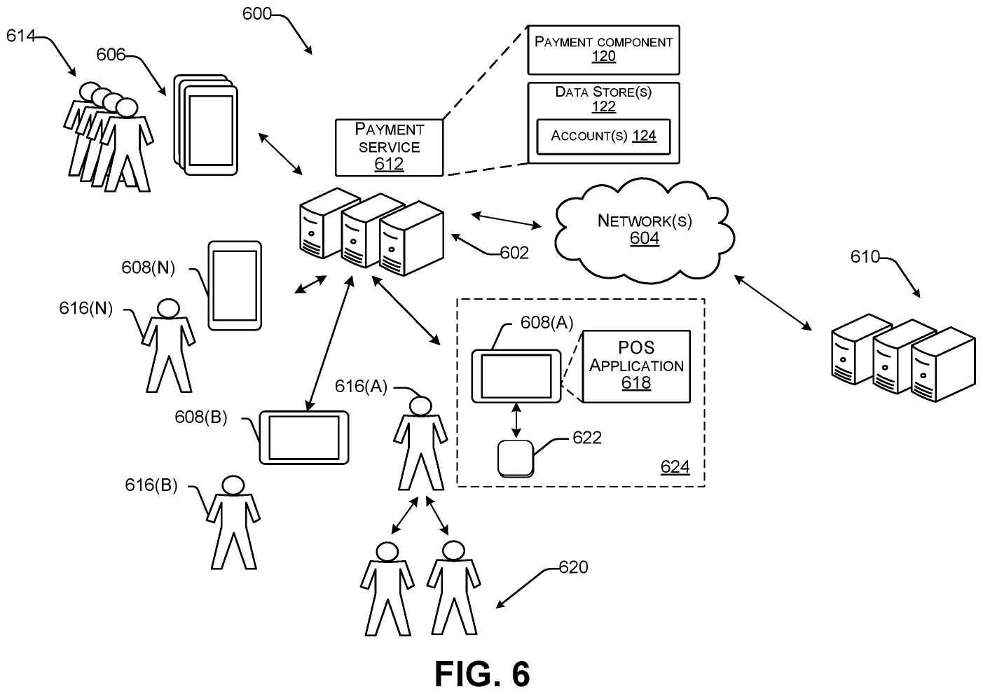

FIG. 6 is an example environment with user devices, merchant devices, a payment service, and/or other systems that may be involved in a transaction, such as by utilizing the payment application as configured herein, according to an embodiment described herein. The environment 600 includes server(s) 602 that can communicate over a network 604 with user devices 606 (which, in some examples can be merchant devices 608 (individually, 608(A)-608(N))) and/or server(s) 610 associated with third-party service provider(s). The server(s) 602 can be associated with a service provider that can provide one or more services for the benefit of users 614, as described below. Actions attributed to the service provider can be performed by the server(s) 602. In examples, the server(s) 602 may be the same as or similar to the payment service 116 from FIG. 1, which may include the same or similar components as described with respect to the payment service 116 of FIG. 1.

The environment 600 can include a plurality of user devices 606, as described above. Each one of the plurality of user devices 606 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 614. The users 614 can be referred to as customers, buyers, merchants, sellers, borrowers, employees, employers, payors, payees, couriers and so on. The users 614 can interact with the user devices 606 via user interfaces presented via the user devices 606. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 606 can have an instance or versioned instance of an application, which can be downloaded from an application store, for example, which can present the user interface(s) described herein. In at least one example, a user 614 can interact with the user interface via touch input, spoken input, or any other type of input.

As described above, in at least one example, the users 614 can include merchants 616 (individually, 616(A)-616(N)). In an example, the merchants 616 can operate respective merchant devices 608, which can be user devices 606 configured for use by merchants 616. For the purpose of this discussion, a “merchant” can be any entity that offers items (e.g., goods or services) for purchase or other means of acquisition (e.g., rent, borrow, barter, etc.). The merchants 616 can offer items for purchase or other means of acquisition via brick-and-mortar stores, mobile stores (e.g., pop-up shops, food trucks, etc.), online stores, combinations of the foregoing, and so forth. In some examples, at least some of the merchants 616 can be associated with a same entity but can have different merchant locations and/or can have franchise/franchisee relationships. In additional or alternative examples, the merchants 616 can be different merchants. That is, in at least one example, the merchant 616(A) is a different merchant than the merchant 616(B) and/or the merchant 616(C).

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

Each merchant device 608 can have an instance of a POS application 618 stored thereon. The POS application 618 can configure the merchant device 608 as a POS terminal, which enables the merchant 616(A) to interact with one or more customers 620. As described above, the users 614 can include customers, such as the customers 620 shown as interacting with the merchant 616(A). For the purpose of this discussion, a “customer” can be any entity that acquires items from merchants. While only two customers 620 are illustrated in FIG. 6, any number of customers 620 can interact with the merchants 616. Further, while FIG. 6 illustrates the customers 620 interacting with the merchant 616(A), the customers 620 can interact with any of the merchants 616.

In at least one example, interactions between the customers 620 and the merchants 616 that involve the exchange of funds (from the customers 620) for items (from the merchants 616) can be referred to as “transactions.” In at least one example, the POS application 618 can determine transaction data associated with the POS transactions. Transaction data can include payment information, which can be obtained from a reader device 622 associated with the merchant device 608(A), user authentication data, purchase amount information, point-of-purchase information (e.g., item(s) purchased, date of purchase, time of purchase, etc.), etc. The POS application 618 can send transaction data to the server(s) 602 such that the server(s) 602 can track transactions of the customers 620, merchants 616, and/or any of the users 614 over time. Furthermore, the POS application 618 can present a UI to enable the merchant 616(A) to interact with the POS application 618 and/or the service provider via the POS application 618.

In at least one example, the merchant device 608(A) can be a special-purpose computing device configured as a POS terminal (via the execution of the POS application 618). In at least one example, the POS terminal may be connected to a reader device 622, which is capable of accepting a variety of payment instruments, such as credit cards, debit cards, gift cards, short-range communication based payment instruments, and the like, as described below. In at least one example, the reader device 622 can plug in to a port in the merchant device 608(A), such as a microphone port, a headphone port, an audio-jack, a data port, or other suitable port. In additional or alternative examples, the reader device 622 can be coupled to the merchant device 608(A) via another wired or wireless connection, such as via a Bluetooth®, BLE, and so on. In some examples, the reader device 622 can read information from alternative payment instruments including, but not limited to, wristbands and the like.

In some examples, the reader device 622 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal may provide a rich user interface, communicate with the reader device 622, and communicate with the server(s) 602, which can provide, among other services, a payment processing service. The server(s) 602 associated with the service provider can communicate with server(s) 610, as described below. In this manner, the POS terminal and reader device 622 may collectively process transaction(s) between the merchants 616 and customers 620. In some examples, POS terminals and reader devices can be configured in one-to-one pairings. In other examples, the POS terminals and reader devices can be configured in many-to-one pairings (e.g., one POS terminal coupled to multiple reader devices or multiple POS terminals coupled to one reader device). In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement may also work in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 622 of the POS system 624 are shown as separate devices, in additional or alternative examples, the POS terminal and the reader device 622 can be part of a single device. In some examples, the reader device 622 can have a display integrated therein for presenting information to the customers 620. In additional or alternative examples, the POS terminal can have a display integrated therein for presenting information to the customers 620. POS systems, such as the POS system 624, may be mobile, such that POS terminals and reader devices may process transactions in disparate locations across the world. POS systems can be used for processing card-present transactions and card-not-present (CNP) transactions, as described below.

A card-present transaction is a transaction where both a customer 620 and his or her payment instrument are physically present at the time of the transaction. Card-present transactions may be processed by swipes, dips, taps, or any other interaction between a physical payment instrument (e.g., a card), or otherwise present payment instrument, and a reader device 622 whereby the reader device 622 is able to obtain payment data from the payment instrument. A swipe is a card-present transaction where a customer 620 slides a card, or other payment instrument, having a magnetic strip through a reader device 622 that captures payment data contained in the magnetic strip. A dip is a card-present transaction where a customer 620 inserts a payment instrument having an embedded microchip (i.e., chip) into a reader device 622 first. The dipped payment instrument remains in the payment reader until the reader device 622 prompts the customer 620 to remove the card, or other payment instrument. While the payment instrument is in the reader device 622, the microchip can create a one-time code which is sent from the POS system 624 to the server(s) 610 (which can be associated with third-party service providers that provide payment services, including but not limited to, an acquirer bank, an issuer, and/or a card payment network (e.g., Mastercard®, VISA®, etc.)) to be matched with an identical one-time code. A tap is a card-present transaction where a customer 620 may tap or hover his or her payment instrument (e.g., card, electronic device such as a smart phone running a payment application, etc.) over a reader device 622 to complete a transaction via short-range communication (e.g., NFC, RFID, Bluetooth®, BLE, etc.). Short-range communication enables the payment instrument to exchange information with the reader device 622. A tap may also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 624, the server(s) 602, and/or the server(s) 610 may exchange payment information and transaction data to determine whether transactions are authorized. For example, the POS system 624 may provide encrypted payment data, user authentication data, purchase amount information, point-of-purchase information, etc. (collectively, transaction data) to server(s) 602 over the network(s) 604. The server(s) 602 may send the transaction data to the server(s) 610. As described above, in at least one example, the server(s) 610 can be associated with third-party service providers that provide payment services, including but not limited to, an acquirer bank, an issuer, and/or a card payment network (e.g., Mastercard®, VISA®, etc.)

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. The acquirer (e.g., the server(s) 610 associated therewith) can send a fund transfer request to a server computing device of a card payment network (e.g., Mastercard®, VISA®, etc.) to determine whether the transaction is authorized or deficient. In at least one example, the service provider can serve as an acquirer and connect directly with the card payment network.

The card payment network (e.g., the server(s) 610 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server(s) 610 associated therewith) can make a determination as to whether the customer has the capacity to absorb the relevant charge associated with the payment transaction. In at least one example, the service provider can serve as an issuer and/or can partner with an issuer. The transaction is either approved or rejected by the issuer and/or the card payment network (e.g., the server(s) 610 associated therewith), and a payment authorization message is communicated from the issuer to the POS device via a path opposite of that described above, or via an alternate path.

As described above, the server(s) 610, which can be associated with payment service provider(s), may determine whether the transaction is authorized based on the transaction data, as well as information relating to parties to the transaction (e.g., the customer 620 and/or the merchant 616(A)). The server(s) 610 may send an authorization notification over the network(s) 604 to the server(s) 602, which may send the authorization notification to the POS system 624 over the network(s) 604 to indicate whether the transaction is authorized. The server(s) 602 may also transmit additional information such as transaction identifiers to the POS system 624. In one example, the server(s) 602 may include a merchant application and/or other functional components for communicating with the POS system 624 and/or the server(s) 610 to authorize or decline transactions.

Based on the authentication notification that is received by the POS system 624 from server(s) 602, the merchant 616(A) may indicate to the customer 620 whether the transaction has been approved. In some examples, approval may be indicated at the POS system 624, for example, at a display of the POS system 624. In other examples, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, and so on. In some examples, the users 614 can access all of the services of the service provider. In other examples, the users 614 can have gradated access to the services, which can be based on risk tolerance, IDV outputs, subscriptions, and so on. In at least one example, access to such services can be availed to the merchants 616 via the POS application 618. In additional or alternative examples, each service can be associated with its own access point (e.g., application, web browser, etc.).

The service provider can offer payment processing services for processing payments on behalf of the merchants 616, as described above. For example, the service provider can provision payment processing software, payment processing hardware and/or payment processing services to merchants 616, as described above, to enable the merchants 616 to receive payments from the customers 620 when conducting POS transactions with the customers 620. For instance, the service provider can enable the merchants 616 to receive cash payments, payment card payments, and/or electronic payments from customers 620 for POS transactions and the service provider can process transactions on behalf of the merchants 616.

As the service provider processes transactions on behalf of the merchants 616, the service provider can maintain accounts or balances for the merchants 616 in one or more ledgers. For example, the service provider can analyze transaction data received for a transaction to determine an amount of funds owed to a merchant 616(A) for the transaction. In at least one example, such an amount can be a total purchase price less fees charged by the service provider for providing the payment processing services. Based on determining the amount of funds owed to the merchant 616(A), the service provider can deposit funds into an account of the merchant 616(A). The account can have a stored balance, which can be managed by the service provider. The account can be different from a conventional bank account at least because the stored balance is managed by a ledger of the service provider and the associated funds are accessible via various withdrawal channels including, but not limited to, scheduled deposit, same-day deposit, instant deposit, and a linked payment instrument.

A scheduled deposit can occur when the service provider transfers funds associated with a stored balance of the merchant 616(A) to a bank account of the merchant 616(A) that is held at a bank or other financial institution (e.g., associated with the server(s) 610). Scheduled deposits can occur at a prearranged time after a POS transaction is funded, which can be a business day after the POS transaction occurred, or sooner or later. In some examples, the merchant 616(A) can access funds prior to a scheduled deposit. For instance, the merchant 616(A) may have access to same-day deposits (e.g., wherein the service provider deposits funds from the stored balance to a linked bank account of the merchant on a same day as POS transaction, in some examples prior to the POS transaction being funded) or instant deposits (e.g., wherein the service provider deposits funds from the stored balance to a linked bank account of the merchant on demand, such as responsive to a request). Further, in at least one example, the merchant 616(A) can have a payment instrument that is linked to the stored balance that enables the merchant to access the funds without first transferring the funds from the account managed by the service provider to the bank account of the merchant 616(A).

In at least one example, the service provider may provide inventory management services. That is, the service provider may provide inventory tracking and reporting. Inventory management services may enable the merchant 616(A) to access and manage a database storing data associated with a quantity of each item that the merchant 616(A) has available (i.e., an inventory). Furthermore, in at least one example, the service provider can provide catalog management services to enable the merchant 616(A) to maintain a catalog, which can be a database storing data associated with items that the merchant 616(A) has available for acquisition (i.e., catalog management services). In at least one example, the catalog may include a plurality of data items and a data item of the plurality of data items may represent an item that the merchant 616(A) has available for acquisition. The service provider can offer recommendations related to pricing of the items, placement of items on the catalog, and multi-party fulfilment of the inventory.

In at least one example, the service provider can provide business banking services, which allow the merchant 616(A) to track deposits (from payment processing and/or other sources of funds) into an account of the merchant 616(A), payroll payments from the account (e.g., payments to employees of the merchant 616(A)), payments to other merchants (e.g., business-to-business) directly from the account or from a linked debit card, withdrawals made via scheduled deposit and/or instant deposit, etc. Furthermore, the business banking services can enable the merchant 616(A) to obtain a customized payment instrument (e.g., credit card), check how much money they are earning (e.g., via presentation of available earned balance), understand where their money is going (e.g., via deposit reports (which can include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 616 to visualize their cash flow to track their financial health, set aside money for upcoming obligations (e.g., savings), organize money around goals, etc.

In at least one example, the service provider can provide financing services and products, such as via business loans, consumer loans, fixed term loans, flexible term loans, and the like. In at least one example, the service provider can utilize one or more risk signals to determine whether to extend financing offers and/or terms associated with such financing offers.

In at least one example, the service provider can provide financing services for offering and/or lending a loan to a borrower that is to be used for, in some instances, financing the borrower's short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider can offer different types of capital loan products. For instance, in at least one example, the service provider can offer a daily repayment loan product, wherein a capital loan is repaid daily, for instance, from a portion of transactions processed by the payment processing service on behalf of the borrower. Additionally and/or alternatively, the service provider can offer a monthly repayment loan product, wherein a capital loan is repaid monthly, for instance, via a debit from a bank account linked to the payment processing service. The credit risk of the merchant may be evaluated using risk models that take into account factors, such as payment volume, credit risk of similarly situated merchants, past transaction history, seasonality, credit history, and so on.

Additionally or alternatively, the service provider can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant, which can be one of the merchants 616. The service provider can generate the loan based at least in part on determining that the borrower purchased or intends to purchase the item from the merchant. The loan can be associated with a balance based on an actual purchase price of the item and the borrower can repay the loan over time. In some examples, the borrower can repay the loan via installments, which can be paid via funds managed and/or maintained by the service provider (e.g., from payments owed to the merchant from payments processed on behalf of the merchant, funds transferred to the merchant, etc.). The service provider can offer specific financial products, such as payment instruments, tied specifically to the loan products. For example, in one implementation, the server provider 612 associates capital to a merchant or customer's debit card, where the use of the debit card is defined by the terms of the loan. In some examples, the merchant may only use the debit card for making specific purchases. In other examples, the “installment” associated with the loan product is credited directly via the payment instrument. The payment instrument is thus customized to the loan and/or the parties associated with the loan.

The service provider can provide web-development services, which enable users 614 who are unfamiliar with HTML, XML, Javascript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items can be used for offering item(s) for sale via an online/e-commerce platform. That is, the resulting web page(s) and/or other content items can be associated with an online store or offering by the one or more of the merchants 616. In at least one example, the service provider can recommend and/or generate content items to supplement omni-channel presences of the merchants 616. That is, if a merchant of the merchants 616 has a web page, the service provider—via the web-development or other services—can recommend and/or generate additional content items to be presented via other channel(s), such as social media, email, etc.

Furthermore, the service provider can provide payroll services to enable employers to pay employees for work performed on behalf of employers. In at least one example, the service provider can receive data that includes time worked by an employee (e.g., through imported timecards and/or POS interactions), sales made by the employee, gratuities received by the employee, and so forth. Based on such data, the service provider can make payroll payments to employee(s) on behalf of an employer via the payroll service. For instance, the service provider can facilitate the transfer of a total amount to be paid out for the payroll of an employee from the bank of the employer to the bank of the service provider to be used to make payroll payments. In at least one example, when the funds have been received at the bank of the service provider, the service provider can pay the employee, such as by check or direct deposit, often a day, a week, or more after when the work was actually performed by the employee. In additional or alternative examples, the service provider can enable employee(s) to receive payments via same-day or instant deposit based at least in part on risk and/or reliability analyses performed by the service provider.

Moreover, in at least one example, the service provider can provide employee management services for managing schedules of employees. Further, the service provider can provide appointment services for enabling users 614 to set schedules for scheduling appointments and/or users 614 to schedule appointments.

In some examples, the service provider can provide restaurant management services to enable users 614 to make and/or manage reservations, to monitor front-of-house and/or back-of-house operations, and so on. In such examples, the merchant device(s) 608 and/or server(s) 602 can be configured to communicate with one or more other computing devices, which can be located in the front-of-house (e.g., POS device(s)) and/or back-of-house (e.g., kitchen display system(s) (KDS)). In at least one example, the service provider can provide order management services and/or fulfillment services to enable restaurants to manage open tickets, split tickets, and so on and/or manage fulfillment services. In some examples, such services can be associated with restaurant merchants, as described above. In additional or alternative examples, such services can be any type of merchant.

In at least one example, the service provider can provide fulfilment services, which can use couriers for delivery, wherein couriers can travel between multiple locations to provide delivery services, photography services, etc. Couriers can be users 614 who can travel between locations to perform services for a requesting user 614 (e.g., deliver items, capture images, etc.). In some examples, the courier can receive compensation from the service provider. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy. Here, essentially any person with a mobile device is able to immediately become a courier, or cease to be a courier, in a courier network that provides services as described herein. In at least one example, the couriers can be unmanned aerial vehicles (e.g., drones), autonomous vehicles, or any other type of vehicle capable of receiving instructions for traveling between locations. In some examples, the service provider can receive requests for courier services, automatically assign the requests to active couriers, and communicate dispatch instructions to couriers via user interface (e.g., application, web browser, or other access point) presented via respective devices 606.

In some examples, the service provider can provide omni-channel fulfillment services. For instance, if a customer places an order with a merchant and the merchant cannot fulfill the order because one or more items are out of stock or otherwise unavailable, the service provider can leverage other merchants and/or sales channels that are part of the platform of the service provider to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the service provider can enable conversational commerce via conversational commerce services, which can use one or more machine learning mechanisms to analyze messages exchanged between two or more users 614, voice inputs into a virtual assistant or the like, to determine intents of user(s) 614. In some examples, the service provider can utilize determined intents to automate customer service, offer promotions, provide recommendations, or otherwise interact with customers in real-time. In at least one example, the service provider can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 614 may be new to the service provider such that the user 614 that has not registered (e.g., subscribed to receive access to one or more services offered by the service provider) with the service provider. The service provider can offer onboarding services for registering a potential user 614 with the service provider. In some examples, onboarding can involve presenting various questions, prompts, and the like to a potential user 614 to obtain information that can be used to generate a profile for the potential user 614. In at least one example, the service provider can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 614 providing all necessary information, the potential user 614 can be onboarded to the service provider. In such an example, any limited or short-term access to services of the service provider can be transitioned to more permissive (e.g., less limited) or longer-term access to such services.

The service provider can be associated with IDV services, which can be used by the service provider for compliance purposes and/or can be offered as a service, for instance to third-party service providers (e.g., associated with the server(s) 610). That is, the service provider can offer IDV services to verify the identity of users 614 seeking to use or using their services. Identity verification requires a customer (or potential customer) to provide information that is used by compliance departments to prove that the information is associated with an identity of a real person or entity. In at least one example, the service provider can perform services for determining whether identifying information provided by a user 614 accurately identifies the customer (or potential customer) (i.e., Is the customer who they say they are?).

The service provider is capable of providing additional or alternative services and the services described above are offered as a sampling of services. In at least one example, the service provider can exchange data with the server(s) 610 associated with third-party service providers. Such third-party service providers can provide information that enables the service provider to provide services, such as those described above. In additional or alternative examples, such third-party service providers can access services of the service provider. That is, in some examples, the third-party service providers can be subscribers, or otherwise access, services of the service provider.

Techniques described herein can be configured to operate in both real-time/online and offline modes. “Online” modes refer to modes when devices are capable of communicating with the service provider (e.g., the server(s) 602) and/or the server(s) 610 via the network(s) 604. In some examples, the merchant device(s) 608 are not capable of connecting with the service provider (e.g., the server(s) 602) and/or the server(s) 610, due to a network connectivity issue, for example. In additional or alternative examples, the server(s) 602 are not capable of communicating with the server(s) 610 due to network connectivity issue, for example. In such examples, devices may operate in “offline” mode where at least some payment data is stored (e.g., on the merchant device(s) 608) and/or the server(s) 602 until connectivity is restored and the payment data can be transmitted to the server(s) 602 and/or the server(s) 610 for processing.

In at least one example, the service provider can be associated with a hub, such as an order hub, an inventory hub, a fulfillment hub and so on, which can enable integration with one or more additional service providers (e.g., associated with the additional server(s) 610). In some examples, such additional service providers can offer additional or alternative services and the service provider can provide an interface or other computer-readable instructions to integrate functionality of the service provider into the one or more additional service providers.

Techniques described herein are directed to services provided via a distributed system of user devices 606 that are in communication with one or more server computing devices 602 of the service provider. That is, techniques described herein are directed to a specific implementation—or, a practical application—of utilizing a distributed system of user devices 606 that are in communication with one or more server computing devices 602 of the service provider to perform a variety of services, as described above. The unconventional configuration of the distributed system described herein enables the server(s) 602 that are remotely-located from end-users (e.g., users 614) to intelligently offer services based on aggregated data associated with the end-users, such as the users 614 (e.g., data associated with multiple, different merchants and/or multiple, different buyers), in some examples, in near-real time. Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein constantly or periodically monitor disparate and distinct merchant accounts, e.g., accounts within the control of the service provider, and those outside of the control of the service provider, to track the business standing (payables, receivables, payroll, invoices, appointments, capital, etc.) of the merchants. The techniques herein provide a consolidated view of a merchant's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 614 and user devices 606. Furthermore, such features are changed dynamically based on the profiles of the users involved interacting with the GUIs. As such, techniques described herein are directed to improvements to computing systems.

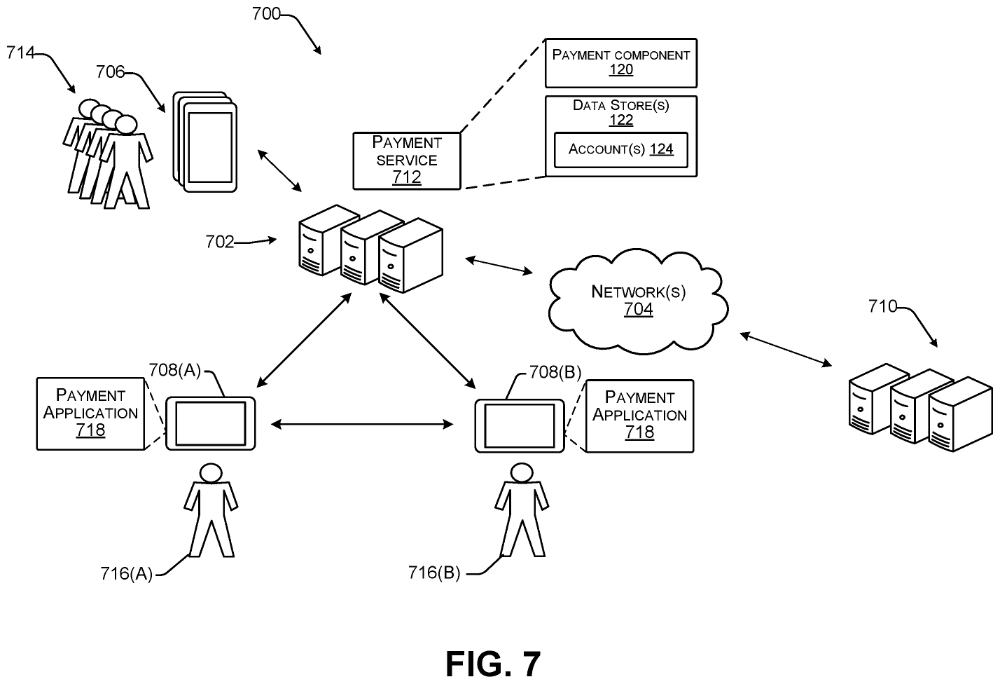

FIG. 7 is an example environment illustrating usage of the payment application, according to an embodiment described herein. The environment 700 includes server(s) 702 that can communicate over a network 704 with user devices 706 (which, in some examples can be user devices 708 (individually, 708(A), 708(B)) and/or server(s) 710 associated with third-party service provider(s). The server(s) 702 can be associated with a service provider that can provide one or more services for the benefit of users 714, as described below. Actions attributed to the service provider can be performed by the server(s) 702. In some examples, the service provider referenced in FIG. 6 can be the same or different than the service provider referenced in FIG. 7. As described herein, the server(s) 702 may be the same or similar to the payment service 116 described with respect to FIG. 1, which may include the same or similar components as described with respect to the payment service 116 of FIG. 1.

The environment 700 can include a plurality of user devices 706, as described above. Each one of the plurality of user devices 706 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 714. The users 714 can be referred to as customers, buyers, merchants, sellers, borrowers, employees, employers, payors, payees, couriers and so on. The users 714 can interact with the user devices 706 via user interfaces presented via the user devices 706. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 706 can have an instance or versioned instance of an application, which can be downloaded from an application store, for example, which can present the user interface(s) described herein. In at least one example, a user 714 can interact with the user interface via touch input, spoken input, or any other type of input.

In at least one example, the service provider can provide a peer-to-peer payment service that enables peer-to-peer payments between two or more users 714. Two users, user 716(A) and user 716(B) are illustrated in FIG. 7 as “peers” in a peer-to-peer payment. In at least one example, the service provider can communicate with instances of a payment application 718 (or other access point) installed on devices 706 configured for operation by users 714. In an example, an instance of the payment application 718 executing on a first device 708(A) operated by a payor (e.g., user 716(A)) can send a request to the service provider to transfer an asset (e.g., fiat currency, non-fiat currency, cryptocurrency, securities, gift cards, and/or related assets) from the payor to a payee (e.g., user 716(B)) via a peer-to-peer payment. In some examples, assets associated with an account of the payor are transferred to an account of the payee. In some examples, assets can be held at least temporarily in an account of the service provider prior to transferring the assets to the account of the payee.

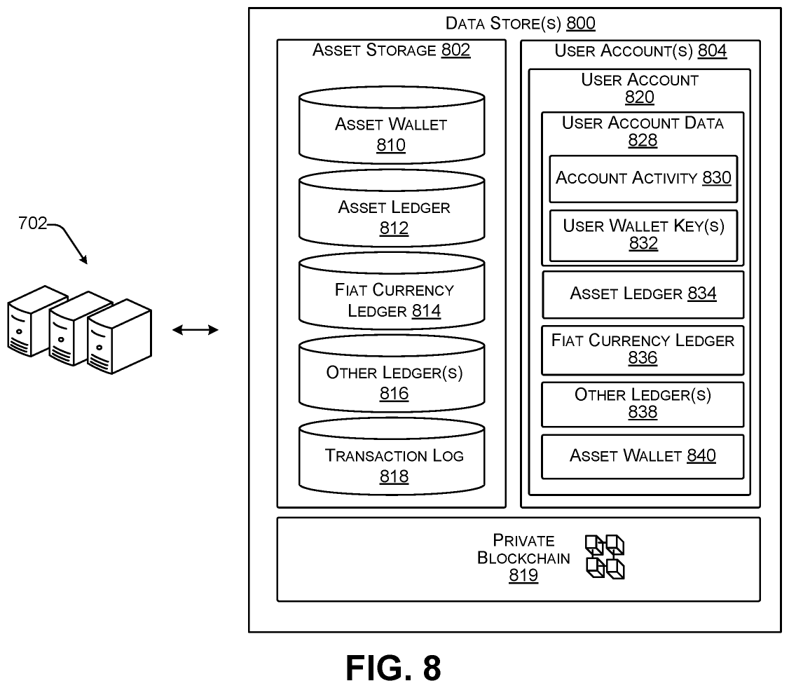

In some examples, the service provider can utilize a ledger system to track transfers of assets between users 706. FIG. 8, below, provides additional details associated with such a ledger system. The ledger system can enable users 706 to own fractional shares of assets that are not conventionally available. For instance, a user can own a fraction of a Bitcoin or a stock. Additional details are described herein.

In at least one example, the service provider can facilitate transfers and can send notifications related thereto to instances of the payment application 718 executing on user device(s) of payee(s). As an example, the service provider can transfer assets from an account of user 716(A) to an account of the user 716(B) and can send a notification to the user device 708(B) of the user 716(B) for presentation via a user interface. The notification can indicate that a transfer is in process, a transfer is complete, or the like. In some examples, the service provider can send additional or alternative information to the instances of the payment application 718 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the service provider funds the request to payee on behalf of the payor, to speed up the transfer process and compensate for any lags that may be attributed to the payor's financial network.

In some examples, the service provider can trigger the peer-to-peer payment process through identification of a “payment proxy” having a particular syntax. For example, the syntax can include a monetary currency indicator prefixing one or more alphanumeric characters (e.g., $Cash). The currency indicator operates as the tagging mechanism that indicates to the server(s) 702 to treat the inputs as a request from the payor to transfer assets, where detection of the syntax triggers a transfer of assets. The currency indicator can correspond to various currencies including but not limited to, dollar ($), euro (€), pound ( [symbol] ), rupee ( [symbol] ), yuan (¥), etc. Although use of the dollar currency indicator ($) is used herein, it is to be understood that any currency symbol could equally be used. In some examples, additional or alternative identifiers can be used to trigger the peer-to-peer payment process. For instance, email, telephone number, social media handles, and/or the like can be used to trigger and/or identify users of a peer-to-peer payment process.

In some examples, the peer-to-peer payment process can be initiated through instances of the payment application 718 executing on the user devices 706. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider can generate the landing page to enable the recipient to conveniently receive one or more payments from one or more senders. In some examples, the personalized location address identifying the landing page can be a uniform resource locator (URL) that incorporates the payment proxy. In such examples, the landing page can be a web page, e.g., www.cash.me/$Cash.

In some examples, the peer-to-peer payment process can be implemented within a forum. The term “forum,” as used here, refers to a given platform (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be employed by the service provider referenced in FIG. 7. For instance, the service provider can offer messaging services that provides a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication. The messaging application can be executed on a user device 706 (e.g., mobile device or conventional personal computer (PC)) based on instructions transmitted to and from the server(s) 702 (which, in such an example can be called a “messaging server”). In some instances, the messaging application can include a payment application with messaging capability that enables users of the payment application to communicate with one another. In such instances, the payment application can be executed on a user device 706 based on instructions transmitted to and from the server(s) 702 (e.g., the payment service discussed in this description or another payment service that supports payment transactions). In some examples, the messaging application can be provided by a third-party service provider associated with the server(s) 710. In examples where the messaging application is a third-party service provider, the server(s) 710 can be accessible via one or more APIs or other integrations.

As described above, the service provider can facilitate peer-to-peer transactions, which can enable users 706 to transfer fiat currency, non-fiat currency, cryptocurrency, securities, or other assets, or portions thereof, to other users 706. In at least one example, individual users can be associated with user accounts. Additional details associated with user accounts and the transfer of assets between users 706 are described below with reference to FIG. 8.

Furthermore, the service provider can enable users 706 to perform banking transactions via instances of the payment application 718. For example, users can configure direct deposits or other deposits for adding assets to their various ledgers/balances. Further, users 706 can configure bill pay, recurring payments, and/or the like using assets associated with their accounts. In addition to sending and/or receiving assets via peer-to-peer transactions, users 706 buy and/or sell assets via asset networks such as cryptocurrency networks, securities networks, and/or the like.

FIG. 8 is an example of data store(s) that can be associated with servers of the payment service, according to an embodiment described herein. In at least one example, the data store(s) 800 can store assets in an asset storage 802, as well as data in user account(s) 804, merchant account(s) 806, and/or customer account(s) 808. In at least one example, the asset storage 802 can be used to store assets managed by the service provider. In at least one example, the asset storage 802 can be used to record whether individual of the assets are registered to users. For example, the asset storage 802 can include an asset wallet 810 for storing records of assets owned by the service provider, such as cryptocurrency, securities, or the like, and communicating with one or more asset networks, such as cryptocurrency networks, securities networks, or the like. In some examples, the asset network can be a first-party network or a third-party network, such as a cryptocurrency exchange or the stock market. In examples where the asset network is a third-party network, the server(s) 710 can be associated therewith. In some examples, the asset wallet 810 can communication with the asset network via one or more components associated with the server(s) 702.

The asset wallet 810 can be associated with one or more addresses and can vary addresses used to acquire assets (e.g., from the asset network(s)) so that its holdings are represented under a variety of addresses on the asset network. In examples where the service provider has its own holdings of cryptocurrency (e.g., in the asset wallet 810), a user can acquire cryptocurrency directly from the service provider. In some examples, the service provider can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In all of these scenarios, the buying and selling of cryptocurrency, and therefore the associated updating of the public ledger of asset network can be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 802 may contain ledgers that store records of assignments of assets to users 706. Specifically, the asset storage 802 may include asset ledger 810, fiat currency ledger 814, and other ledger(s) 816, which can be used to record transfers of assets between users 706 of the service provider and/or one or more third-parties (e.g., merchant network(s), payment card network(s), ACH network(s), equities network(s), the asset network, securities networks, etc.). In doing so, the asset storage 802 can maintain a running balance of assets managed by the service provider. The ledger(s) of the asset storage 802 can further indicate some of the running balance for each of the ledger(s) stored in the asset storage 802 is assigned or registered to one or more user account(s) 804.

In at least one example, the asset storage 802 can include transaction logs 818, which can include records of past transactions involving the service provider. In at least one example, transaction data, as described herein, can be stored in association with the transaction logs 818.

In some examples, the data store(s) 800 can store a private blockchain 819. A private blockchain 819 can function to record sender addresses, recipient addresses, public keys, values of cryptocurrency transferred, and/or can be used to verify ownership of cryptocurrency tokens to be transferred. In some examples, the service provider can record transactions taking place within the service provider involving cryptocurrency until the number of transactions has exceeded a determined limit (e.g., number of transactions, storage space allocation, etc.). Based at least in part on determining that the limit has been reached, the service provider can publish the transactions in the private blockchain 819 to a public blockchain (e.g., associated with the asset network), where miners can verify the transactions and record the transactions to blocks on the public blockchain. In at least one example, the service provider can participate as miner(s) at least for its transactions to be posted to the public blockchain.

In at least one example, the data store(s) 800 can store and/or manage accounts, such as user account(s) 804, merchant account(s) 806, and/or customer account(s) 808. In at least one example, the user account(s) 804 may store records of user accounts associated with the users 706. In at least one example, the user account(s) 804 can include a user account 820, which can be associated with a user (of the users 706). Other user accounts of the user account(s) 804 can be similarly structured to the user account 820, according to some examples. In other examples, other user accounts may include more or less data and/or account information than that provided by the user account 820. In at least one example, the user account 820 can include user account data 1828, which can include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1828 can include account activity 1830 and user wallet key(s) 1832. The account activity 1830 may include a transaction log for recording transactions associated with the user account 820. In some examples, the user wallet key(s) 1832 can include a public-private key-pair and a respective address associated with the asset network or other asset networks. In some examples, the user wallet key(s) 1832 may include one or more key pairs, which can be unique to the asset network or other asset networks.

In addition to the user account data 1828, the user account 820 can include ledger(s) for account(s) managed by the service provider, for the user. For example, the user account 820 may include an asset ledger 1834, a fiat currency ledger 1836, and/or one or more other ledgers 1838. The ledger(s) can indicate that a corresponding user utilizes the service provider to manage corresponding accounts (e.g., a cryptocurrency account, a securities account, a fiat currency account, etc.). It should be noted that in some examples, the ledger(s) can be logical ledger(s) and the data can be represented in a single database. In some examples, individual of the ledger(s), or portions thereof, can be maintained by the service provider.

In some examples, the asset ledger 1834 can store a balance for each of one or more cryptocurrencies (e.g., Bitcoin, Ethereum, Litecoin, etc.) registered to the user account 820. In at least one example, the asset ledger 1834 can further record transactions of cryptocurrency assets associated with the user account 820. For example, the user account 820 can receive cryptocurrency from the asset network using the user wallet key(s) 1832. In some examples, the user wallet key(s) 1832 may be generated for the user upon request. User wallet key(s) 1832 can be requested by the user in order to send, exchange, or otherwise control the balance of cryptocurrency held by the service provider (e.g., in the asset wallet 810) and registered to the user. In some examples, the user wallet key(s) 1832 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider and the value is credited as a balance in asset ledger 1834), by purchasing currency in the form associated with the account using currency in a different form (e.g., buying a value of cryptocurrency from the service provider using a value of fiat currency reflected in fiat currency ledger 814, and crediting the value of cryptocurrency in asset ledger 1834), or by conducting a transaction with another user (customer or merchant) of the service provider wherein the account receives incoming currency (which can be in the form associated with the account or a different form, in which the incoming currency may be converted to the form associated with the account). In some examples, the user account data 1828 can include preferences for maintaining balances of individual of the ledgers. For example, the service provider can automatically debit the fiat currency ledger 1836 to increase the asset ledger 1834, or another account associated with the user whenever the cryptocurrency balance (e.g., of the asset ledger 1834) falls below a stated level (e.g., a threshold). Conversely, in some embodiments, the service provider can automatically credit the fiat currency ledger 1836 to decrease the asset ledger 1834 whenever cryptocurrency balance rises above a stated level (e.g., a threshold). In some examples, automatic transactions can be further defined by an exchange rate between the cryptocurrency and the fiat currency such that transactions to buy or sell cryptocurrency can occur when exchange rates are favorable.

With specific reference to funding a cryptocurrency account, a user may have a balance of cryptocurrency stored in another cryptocurrency wallet. In some examples, the other cryptocurrency wallet can be associated with a third-party (e.g., associated with the third-party server(s)) unrelated to the service provider (i.e., an external account). In at least one example, the user can transfer all or a portion of a balance of the cryptocurrency stored in the third-party cryptocurrency wallet to the service provider. Such a transaction can require the user to transfer an amount of the cryptocurrency in a message signed by user's private key to an address provided by the service provider. In at least one example, the transaction can be sent to miners to bundle the transaction into a block of transactions and to verify the authenticity of the transactions in the block. Once a miner has verified the block, the block is written to a public, distributed blockchain where the service provider can then verify that the transaction has been confirmed and can credit the user's asset ledger 1834 with the transferred amount. When an account is funded by transferring cryptocurrency from a third-party cryptocurrency wallet, an update can be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider. As described above, in some examples, the service provider can acquire cryptocurrency from a third-party source (e.g., associated with the third-party server(s) 118). In such examples, the asset wallet 810 can be associated with different addresses and can vary addresses used to acquire cryptocurrency so that its holdings are represented under a variety of addresses on a blockchain. When the service provider has their own holdings of cryptocurrency, users can acquire cryptocurrency directly from the service provider. In some examples, the service provider can include logic for buying and selling cryptocurrency in order to maintain a desired level of cryptocurrency. The desired level can be based on a volume of transactions over a period, balances of collective user profiles cryptocurrency ledgers, exchange rates, or trends in changing of exchange rates such that the cryptocurrency is trending towards gaining or losing value with respect to the fiat currency. In all of these examples, the buying and selling of cryptocurrency, and therefore the associated updating of the public ledger can be separate from any customer-merchant transaction, and therefore not necessarily time-sensitive.

In examples where the service provider has its own cryptocurrency assets, cryptocurrency transferred in a transaction (e.g., data with address provided for receipt of transaction and a balance of cryptocurrency transferred in the transaction) can be stored in the asset wallet 810. In at least one example, the service provider can credit the asset ledger 1834 of the user. Additionally, while the service provider recognizes that the user retains the value of the transferred cryptocurrency through crediting the asset ledger 1834, any person that inspects the blockchain will see the cryptocurrency as having been transferred to the service provider. In some examples, the asset wallet 810 can be associated with many different addresses. In such examples, any person that inspects the blockchain may not easily associate all cryptocurrency stored in asset wallet 810 as belonging to the same entity. It is this presence of a private ledger that is used for real-time transactions and maintained by the service provider, combined with updates to the public ledger at other times, that allows for extremely fast transactions using cryptocurrency to be achieved. In some examples, the “private ledger” can refer to the asset ledger 810, which in some examples, can utilize the private blockchain 819, as described herein. The “public ledger” can correspond to a public blockchain associated with the asset network.

In at least one example, a user's asset ledger 1834, fiat currency ledger 1836, or the like can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1834. In some examples, a user can receive fiat currency or another currency in the form of payment for a transaction with another user. In at least one example, at least a portion of such funds can be converted into cryptocurrency by the service provider and used to fund the asset ledger 1834 of the user.

As addressed above, in some examples, users can also have other accounts maintained by the service provider. For example, a user can also have an account in U.S. dollars, which can be tracked, for example, via the fiat currency ledger 1836. Such an account can be funded by transferring money from a bank account at a third-party bank to an account maintained by the service provider as is conventionally known. In some examples, a user can receive fiat currency in the form of payment for a transaction with another user. In such examples, at least a portion of such funds can be used to fund the fiat currency ledger 1836.

In some examples, a user can have one or more internal payment cards registered with the service provider. Internal payment cards can be linked to one or more of the accounts associated with the user account 820. In some embodiments, options with respect to internal payment cards can be adjusted and managed using an application (e.g., the payment application 718).

In at least one example, as described above, each ledger can correspond to an account of the user that is managed by the service provider. In at least one example, individual of the accounts can be associated with a wallet or a stored balance for use in payment transactions, peer-to-peer transactions, payroll payments, etc.

In at least one example, the user account 820 can be associated with an asset wallet 1840. The asset wallet 1840 of the user can be associated with account information that can be stored in the user account data 1828 and, in some examples, can be associated with the user wallet key(s) 1832. In at least one example, the asset wallet 1840 can store data indicating an address provided for receipt of a cryptocurrency transaction. In at least one example, the balance of the asset wallet 1840 can be based at least in part on a balance of the asset ledger 1834. In at least one example, funds availed via the asset wallet 1840 can be stored in the asset wallet 1840 or the asset wallet 810. Funds availed via the asset wallet 810 can be tracked via the asset ledger 1834. The asset wallet 1840, however, can be associated with additional cryptocurrency funds.

In at least one example, when the service provider includes a private blockchain 819 for recording and validating cryptocurrency transactions, the asset wallet 1840 can be used instead of, or in addition to, the asset ledger 1834. For example, at least one example, a merchant can provide the address of the asset wallet 1840 for receiving payments. In an example where a customer is paying in cryptocurrency and the customer has their own cryptocurrency wallet account associated with the service provider, the customer can send a message signed by its private key including its wallet address (i.e., of the customer) and identifying the cryptocurrency and value to be transferred to the merchant's asset wallet 1840. The service provider can complete the transaction by reducing the cryptocurrency balance in the customer's cryptocurrency wallet and increasing the cryptocurrency balance in the merchant's asset wallet 1840. In addition to recording the transaction in the respective cryptocurrency wallets, the transaction can be recorded in the private blockchain 819 and the transaction can be confirmed. A user can perform a similar transaction with cryptocurrency in a peer-to-peer transaction as described above. In at least one example, the cryptocurrency wallet account 1830 can be funded by a balance transfer from a third-party cryptocurrency wallet, as described above. Such a transaction can require a user to transfer an amount of cryptocurrency in a message signed by the user's private key to an address of the cryptocurrency wallet account 1830. The transferred amount of cryptocurrency can then be within the cryptocurrency wallet account 1830 for use in later transactions.

While the asset ledger 1834 and/or asset wallet 1840 are each described above with reference to cryptocurrency, the asset ledger 1834 and/or asset wallet 1840 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider is an aspect of the technology disclosed that enables technical advantages of increased processing speed and improved security.

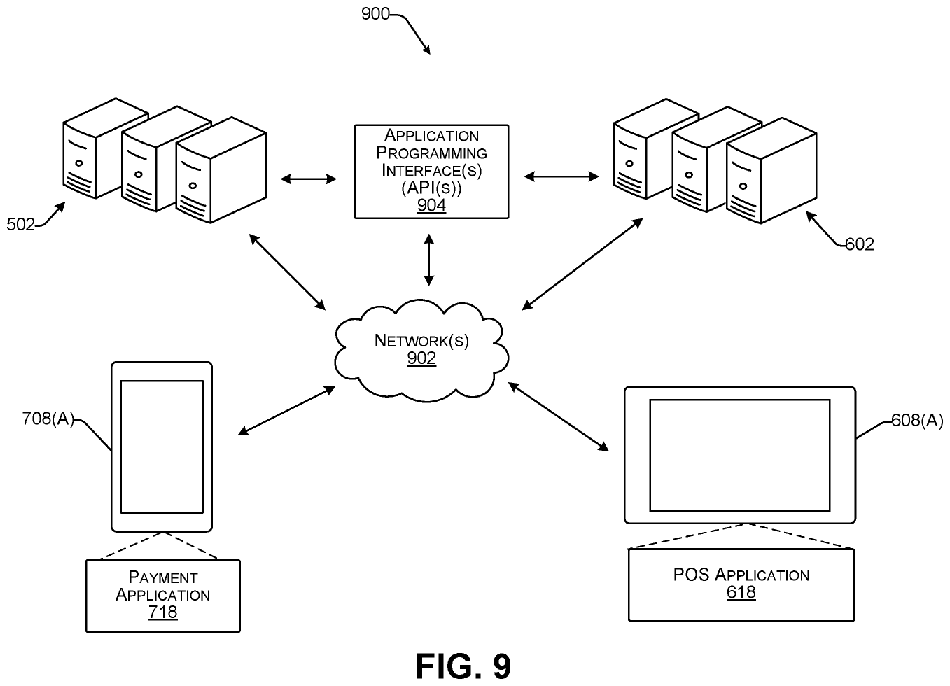

FIG. 9 is an example environment 900 wherein the environment 600 and the environment 700 can be integrated to enable payments at the point-of-sale using assets associated with user accounts in the peer-to-peer environment of FIG. 7, according to an embodiment described herein. As illustrated, each of the components can communicate with one another via one or more networks 902. In some examples, one or more APIs 904 or other functional components can be used to facilitate such communication. For example, the APIs 904 can be used to facilitate communication with payment service server(s) 702 and server(s) 710 associated with third-party service provider(s).

In at least one example, the example environment 900 can enable contactless payments, via integration of peer-to-peer payment, or other payment making, platform(s) and payment processing platform(s), are described herein. For the purpose of FIG. 9, the environment 600 can refer to a payment processing platform and the environment 700 can refer to a peer-to-peer payment, or payment making, platform. In an example, such an integration can enable a customer to participate in a transaction via their own computing device instead of interacting with a merchant device of a merchant, such as the merchant device 608(A). In such an example, the POS application 618, associated with a payment processing platform and executable by the merchant device 608(A) of the merchant, can present a Quick Response (QR) code, or other code that can be used to identify a transaction (e.g., a transaction code), in association with a transaction between the customer and the merchant. The QR code, or other transaction code, can be provided to the POS application 618 via an API associated with the peer-to-peer payment platform. In an example, the customer can utilize their own computing device, such as the user device 708(A), to capture the QR code, or the other transaction code, and to provide an indication of the captured QR code, or other transaction code, to server(s) 602 and/or server(s) 702.

Based at least in part on the integration of the peer-to-peer payment platform and the payment processing platform (e.g., via the API), the server(s) 602 and/or 702 associated with each can exchange communications with each other and with a payment application 718 associated with the peer-to-peer payment platform and/or the POS application 618 to process payment for the transaction using a peer-to-peer payment where the customer is a first “peer” and the merchant is a second “peer.” In at least one example, the peer-to-peer payment platform can transfer funds from an account of the customer, maintained by the peer-to-peer payment platform, to an account of the merchant, maintained by the payment processing platform, thereby facilitating a contactless (peer-to-peer) payment for the transaction. That is, based at least in part on receiving an indication of which payment method a user (e.g., customer or merchant) intends to use for a transaction, techniques described herein utilize an integration between a peer-to-peer payment platform and payment processing platform (which can be a first- or third-party integration) such that a QR code, or other transaction code, specific to the transaction can be used for providing transaction details, location details, customer details, or the like to a computing device of the customer, such as the user device 708(A), to enable a contactless (peer-to-peer) payment for the transaction.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 708(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 618 and the payment application 718, as described herein, can process a payment transaction by routing information input via the merchant application to the payment application for completing a “frictionless” payment. This can be referred to as “in-application payment.” in another example of “in-application payment,” the payment application described herein can be created or modified via a software developer kit (SDK) to enable in-application payment.

Returning to the “scan to pay” examples described herein. QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. In such a “scan to pay” example, a customer computing device, such as the user device 708(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc.

In an example, a customer can desire to purchase items from a merchant. When the customer approaches the merchant to check out, the merchant (e.g., a worker associated therewith) can add indications of the items to a virtual cart via the POS application 618, associated with a payment processing platform, on the merchant device 608(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, a display of the merchant device 608(A) can present a QR code, or other transaction code, that can be associated with a peer-to-peer payment platform. The customer can use a camera associated with the user device 708(A) to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction between the customer computing device and the QR code can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As an additional or alternative example, a customer can desire to purchase items from a merchant. When the customer approaches the merchant to check out, the merchant (e.g., a worker associated therewith) can add indications of the items to a virtual cart via the POS application 618, associated with a payment processing platform, on the merchant device 608(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, the POS application 618 can cause a message with a resource locator (e.g., uniform resource locator (URL)) that can be associated with a peer-to-peer payment platform to be sent to the user device 708(A). The customer can interact with the resource locator and, if the customer is already associated with the peer-to-peer payment platform (e.g., has an existing account, previously onboarded, etc.), the peer-to-peer payment platform can provide an indication of the interaction with the resource locator to the payment processing platform. This interaction—between the customer and the resource locator presented via the customer computing device—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. As described above, such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

The same or similar techniques can be applicable in online and/or ecommerce selling channels as well. In such an example, a QR code, or other transaction code, can be presented via an online store/ecommerce web page of a merchant. The customer can use a camera associated with a customer computing device, such as the user device 708(A), to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction between the customer computing device and the QR code can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As described above, techniques described herein offer improvements to conventional payment technologies. In an example, techniques described herein can enable transaction data to be sent from a POS application 618 of a merchant device 608(A) at a brick-and-mortar store of a merchant to a payment application 718 of a user device 708(A) of a customer to enable the customer to participate in a transaction via their own computing device. For instance, in a “scan to pay” example as described above, based at least in part on capturing the QR code, or other transaction code, via the user device 708(A), the payment processing platform can provide transaction data to the peer-to-peer payment platform for presentation via the payment application 718 on the user device 708(A). In some examples, the customer can watch items being added to their cart (e.g., via a user interface presented via the payment application). As an item is added to a virtual cart by the merchant—via the POS application 618 on the merchant device 608(A) of the merchant—the customer can see the item in their virtual cart on their own computing device in near-real time. In another example, the peer-to-peer payment platform can analyze transaction data as it is received to determine whether an incentive (e.g., a discount, a loyalty reward, prioritized access or booking, etc.) is applicable to the transaction and can automatically apply the incentive or send a recommendation to the payment application 718 for presentation via a user interface associated therewith. In addition to enabling a customer to participate in a transaction during cart building, techniques described herein can enable a customer to complete a transaction, and in some examples, provide gratuity (i.e., a tip), feedback, loyalty information, or the like, via the user device 708(A) during or after payment of the transaction.

In some examples, based at least in part on capturing the QR code, or other transaction code, the payment processing platform can provide transaction data to the peer-to-peer payment platform for presentation via the payment application 718 on the computing device of the customer, such as the user device 708(A), to enable the customer to complete the transaction via their own computing device, in some examples, in response to receiving an indication that the QR code, or other transaction code, has been captured or otherwise interacted with via the customer computing device, the peer-to-peer payment platform can determine that the customer authorizes payment of the transaction using funds associated with a stored balance of the customer that is managed and/or maintained by the peer-to-peer payment platform. Such authorization can be implicit such that the interaction with the transaction code can imply authorization of the customer. In some examples, in response to receiving an indication that the QR code, or other transaction code, has been captured or otherwise interacted with via the customer computing device, the peer-to-peer payment platform can request authorization to process payment for the transaction using the funds associated with the stored balance and the customer can interact with the payment application to authorize the settlement of the transaction. A response to such a request can provide an express authorization of the customer. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the peer-to-peer payment platform can transfer funds from the stored balance of the customer to the payment processing platform. In at least one example, the payment processing platform can deposit the funds, or a portion thereof, into a stored balance of the merchant that is managed and/or maintained by the payment processing platform. That is, techniques described herein enable the peer-to-peer payment platform to transfer funds to the payment processing platform to settle payment of the transaction. In such an example, the payment processing platform can be a “peer” to the customer in a peer-to-peer transaction.

In some examples, techniques described herein can enable the customer to interact with the transaction after payment for the transaction has been settled. For example, in at least one example, the payment processing platform can cause a total amount of a transaction to be presented via a user interface associated with the payment application 718 such that the customer can provide gratuity, feedback, loyalty information, or the like, via, an interaction with the user interface. In some examples, because the customer has already authorized payment via the peer-to-peer payment platform, if the customer inputs a tip, the peer-to-peer payment platform can transfer additional funds, associated with the tip, to the payment processing platform. This pre-authorization (or maintained authorization) of sorts can enable faster, more efficient payment processing when the tip is received. Further, the customer can provide feedback and/or loyalty information via the user interface presented by the payment application, which can be associated with the transaction.

As described above—and also below—techniques described herein enable contactless payments. That is, by integrating the payment processing platform with the peer-to-peer payment platform, merchants and customers can participate in transactions via their own computing devices without needing to touch, or otherwise be in contact, with one another. By moving aspects of a transaction that are traditionally performed on a computing device of a merchant to a computing device of a customer, customers can have more control over the transaction and can have more privacy. That is, customers can monitor items that are added to their cart to ensure accuracy. Further, customers can authorize payments, use rewards, claim incentives, add gratuity, or the like without being watched by the merchant or other customers.

In some examples, such as when the QR code, or other transaction code, is captured by the computing device of the customer prior to a payment selection user interface being presented via the POS application 618, payment for the transaction can be pre-authorized such that when the time comes to complete the transaction, neither the payment processing platform nor the peer-to-peer payment platform need to re-authorize payment at that time. That is, techniques described herein can enable faster, more efficient transactions. Further, in some examples, when a customer adds a tip after payment for a transaction has been settled, in some examples, because the peer-to-peer payment platform has already been authorized, the peer-to-peer payment platform and the payment processing platform may not need to obtain another authorization to settle funds associated with the tip. That is, in such examples, fewer data transmissions are required and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 718 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, instead of scanning, capturing, or otherwise interacting with a QR code or transaction code, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. For example, based at least in part on detecting a dip, tap, swipe, or the like, the payment processing platform can associate a customer with a transaction and provide at least a portion of transaction data associated with the transaction to a customer computing device associated therewith. In some examples, the payment instrument can be associated with the peer-to-peer payment platform as described herein (e.g., a debit card linked to a stored balance of a customer) such that when the payment instrument is caused to interact with a payment reader, the payment processing platform can exchange communications with the peer-to-peer payment platform to authorize payment for a transaction and/or provision associated transaction data to a computing device of the customer associated with the transaction.

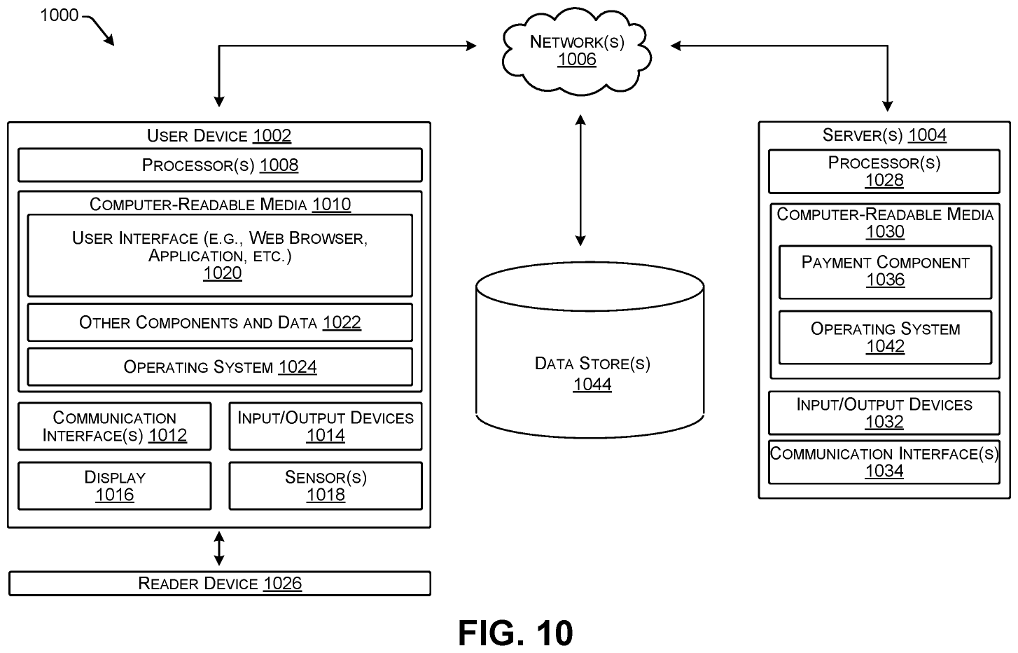

FIG. 10 is an illustrative block diagram illustrating a system for performing techniques described herein, according to an embodiment described herein. The system 1000 includes a user device 1002, that communicates with server computing device(s) (e.g., server(s) 1004) via network(s) 1006 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1002 is illustrated, in additional or alternate examples, the system 1000 can have multiple user devices, as described above with reference to FIG. 10. The user device 1002 may be the same or similar to the customer device 104 and/or the merchant device 110 as described with respect to FIG. 1. Additionally, the server(s) 1004 may be the same or similar to the payment service 116 described with respect to FIG. 1.

In at least one example, the user device 1002 can be any suitable type of computing device, e.g., portable, semi-portable, semi-stationary, or stationary. Some examples of the user device 1002 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 1002 can be any computing device capable of sending communications and performing the functions according to the techniques described herein. The user device 1002 can include devices, e.g., payment card readers, or components capable of accepting payments, as described below.

In the illustrated example, the user device 1002 includes one or more processors 1008, one or more computer-readable media 1010, one or more communication interface(s) 1012, one or more input/output (I/O) devices 1014, a display 1016, and sensor(s) 1018.

In at least one example, each processor 1008 can itself comprise one or more processors or processing cores. For example, the processor(s) 1008 can be implemented as one or more microprocessors, microcomputers, microcontrollers, digital signal processors, central processing units, state machines, logic circuitries, and/or any devices that manipulate signals based on operational instructions. In some examples, the processor(s) 1008 can be one or more hardware processors and/or logic circuits of any suitable type specifically programmed or configured to execute the algorithms and processes described herein. The processor(s) 1008 can be configured to fetch and execute computer-readable processor-executable instructions stored in the computer-readable media 1010.

Depending on the configuration of the user device 1002, the computer-readable media 1010 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1010 can include, but is not limited to, RAM, ROM, EEPROM, flash memory, solid-state storage, magnetic disk storage, optical storage, and/or other computer-readable media technology. Further, in some examples, the user device 1002 can access external storage, such as RAID storage systems, storage arrays, network attached storage, storage area networks, cloud storage, or any other medium that can be used to store information and that can be accessed by the processor(s) 1008 directly or through another computing device or network. Accordingly, the computer-readable media 1010 can be computer storage media able to store instructions, components or components that can be executed by the processor(s) 1008. Further, when mentioned, non-transitory computer-readable media exclude media such as energy, carrier signals, electromagnetic waves, and signals per se.

The computer-readable media 1010 can be used to store and maintain any number of functional components that are executable by the processor(s) 1008. In some implementations, these functional components comprise instructions or programs that are executable by the processor(s) 1008 and that, when executed, implement operational logic for performing the actions and services attributed above to the user device 1002. Functional components stored in the computer-readable media 1010 can include a user interface 1020 to enable users to interact with the user device 1002, and thus the server(s) 1004 and/or other networked devices. In at least one example, the user interface 1020 can be presented via a web browser, or the like. In other examples, the user interface 1020 can be presented via an application, such as a mobile application or desktop application, which can be provided by a service provider associated with the server(s) 1004, or which can be an otherwise dedicated application. In some examples, the user interface 1020 can be configured to display options for withdrawing funds to make donations. The user interface 1020 may also be configured to surface information about donations. In at least one example, a user can interact with the user interface via touch input, spoken input, gesture, or any other type of input. The word “input” is also used to describe “contextual” input that may not be directly provided by the user via the user interface 1020. For example, user's interactions with the user interface 1020 are analyzed using, e.g., natural language processing techniques, to determine context or intent of the user, which may be treated in a manner similar to “direct” user input.

Depending on the type of the user device 1002, the computer-readable media 1010 can also optionally include other functional components and data, such as other components and data 1022, which can include programs, drivers, etc., and the data used or generated by the functional components. In addition, the computer-readable media 1010 can also store data, data structures and the like, that are used by the functional components. Further, the user device 1002 can include many other logical, programmatic and physical components, of which those described are merely examples that are related to the discussion herein.

In at least one example, the computer-readable media 1010 can include additional functional components, such as an operating system 1024 for controlling and managing various functions of the user device 1002 and for enabling basic user interactions.

The communication interface(s) 1012 can include one or more interfaces and hardware components for enabling communication with various other devices, such as over the network(s) 1006 or directly. For example, communication interface(s) 1012 can enable communication through one or more network(s) 1006, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1006 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1002 can further include one or more input/output (I/O) devices 1014. The I/O devices 1014 can include speakers, a microphone, a camera, and various user controls (e.g., buttons, a joystick, a keyboard, a keypad, etc.), a haptic output device, and so forth. The I/O devices 1014 can also include attachments that leverage the accessories (audio-jack, USB-C, Bluetooth, etc.) to connect with the user device 1002.

In at least one example, user device 1002 can include a display 1016. Depending on the type of computing device(s) used as the user device 1002, the display 1016 can employ any suitable display technology. For example, the display 1016 can be a liquid crystal display, a plasma display, a light emitting diode display, an OLED (organic light-emitting diode) display, an electronic paper display, or any other suitable type of display able to present digital content thereon. In at least one example, the display 1016 can be an augmented reality display, a virtually reality display, or any other display able to present and/or project digital content. In some examples, the display 1016 can have a touch sensor associated with the display 1016 to provide a touchscreen display configured to receive touch inputs for enabling interaction with a graphic interface presented on the display 1016. Accordingly, implementations herein are not limited to any particular display technology. Alternatively, in some examples, the user device 1002 may not include the display 1016, and information can be presented by other means, such as aurally, haptically, etc.

In addition, the user device 1002 can include sensor(s) 1018. The sensor(s) 1018 can include a GPS device able to indicate location information. Further, the sensor(s) 1018 can include, but are not limited to, an accelerometer, gyroscope, compass, proximity sensor, camera, microphone, and/or a switch.

In some example, the GPS device can be used to identify a location of a user. In at least one example, the location of the user can be used by the service provider 1024, described above, to provide one or more services. That is, in some examples, the service provider 1024 can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users 1014 and/or for sending users 1014 notifications regarding available appointments with merchant(s) located proximate to the users 1014. In at least one example, location can be used for taking payments from nearby customers when they leave a geofence, or location can be used to initiate an action responsive to users 1014 enter a brick-and-mortar store of a merchant. Location can be used in additional or alternative ways as well.

Additionally, the user device 1002 can include various other components that are not shown, examples of which include removable storage, a power source, such as a battery and power control unit, a barcode scanner, a printer, a cash drawer, and so forth.

In addition, in some examples, the user device 1002 can include, be connectable to, or otherwise be coupled to a reader device 1026, for reading payment instruments and/or identifiers associated with payment objects. In some examples, as described above, the reader device 1026 can plug in to a port in the user device 1002, such as a microphone port, a headphone port, an audio-jack, a data port, or other suitable port. In additional or alternative examples, the reader device 1026 can be coupled to the user device 1002 via another wired or wireless connection, such as via a Bluetooth®, BLE, and so on. The reader device 1026 can include a read head for reading a magnetic strip of a payment card, and further can include encryption technology for encrypting the information read from the magnetic strip. Additionally or alternatively, the reader device 1026 can be an EMV payment reader, which in some examples, can be embedded in the user device 1002. Moreover, numerous other types of readers can be employed with the user device 1002 herein, depending on the type and configuration of the user device 1002.

The reader device 1026 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 1026 may include hardware implementation, such as slots, magnetic tracks, and rails with one or more sensors or electrical contacts to facilitate detection and acceptance of a payment instrument. That is, the reader device 1026 may include hardware implementations to enable the reader device 1026 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her electronic device such as a smart phone running a payment application over a payment reader to complete a transaction via short-range communication) to obtain payment data associated with a customer. Additionally or optionally, the reader device 1026 may also include a biometric sensor to receive and process biometric characteristics and process them as payment instruments, given that such biometric characteristics are registered with the payment service 104 and connected to a financial account with a bank server.

The reader device 1026 may include processing unit(s), computer-readable media, a reader chip, a transaction chip, a timer, a clock, a network interface, a power supply, and so on. The processing unit(s) of the reader device 1026 may execute one or more components and/or processes to cause the reader device 1026 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program components, program data, and/or one or more operating systems. Depending on the exact configuration and type of the reader device 1026, the computer-readable media may include volatile memory (such as RAM), non-volatile memory (such as ROM, flash memory, miniature hard drive, memory card, or the like), or some combination thereof. In at least one example, the computer-readable media of the reader device 1026 may include at least one component for performing various functions as described herein.

The reader chip may perform functionalities to control the operations and processing of the reader device 1026. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock 1012, which may provide a clock signal indicating a time. Furthermore, the reader chip may perform functionality to control the network interface, which may interface with the network(s) 1006, as described below.

Additionally, the reader chip may perform functionality to control the power supply. The power supply may include one or more power supplies such as a physical connection to AC power or a battery. Power supply may include power conversion circuitry for converting AC power and generating a plurality of DC voltages for use by components of reader device 1026. When power supply includes a battery, the battery may be charged via a physical power connection, via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While, the user device 1002, which can be a POS terminal, and the reader device 1026 are shown as separate devices, in additional or alternative examples, the user device 1002 and the reader device 1026 can be part of a single device, which may be a battery-operated device. In such an example, components of both the user device 1002 and the reader device 1026 may be associated with the single device. In some examples, the reader device 1026 can have a display integrated therewith, which can be in addition to (or as an alternative of) the display 1016 associated with the user device 1002.

The server(s) 1004 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1004 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1004 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 1004 can include one or more processors 1028, one or more computer-readable media 1030, one or more I/O devices 1032, and one or more communication interfaces 1034. Each processor 1028 can be a single processing unit or a number of processing units, and can include single or multiple computing units or multiple processing cores. The processor(s) 1028 can be implemented as one or more microprocessors, microcomputers, microcontrollers, digital signal processors, central processing units, state machines, logic circuitries, and/or any devices that manipulate signals based on operational instructions. For example, the processor(s) 1028 can be one or more hardware processors and/or logic circuits of any suitable type specifically programmed or configured to execute the algorithms and processes described herein. The processor(s) 1028 can be configured to fetch and execute computer-readable instructions stored in the computer-readable media 1030, which can program the processor(s) 1028 to perform the functions described herein.

The computer-readable media 1030 can include volatile and nonvolatile memory and/or removable and non-removable media implemented in any type of technology for storage of information, such as computer-readable instructions, data structures, program components, or other data. Such computer-readable media 1030 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1004, the computer-readable media 1030 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1030 can be used to store any number of functional components that are executable by the processor(s) 1028. In many implementations, these functional components comprise instructions or programs that are executable by the processors 1028 and that, when executed, specifically configure the one or more processors 1028 to perform the actions attributed above to the service provider and/or payment processing service.

The other components may include a training component that can be configured to train models using machine-learning mechanisms. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 1002 and/or the server(s) 1004 for use at a time after the data models have been trained (e.g., at runtime).

The one or more other components and data can include programs, drivers, etc., and the data used or generated by the functional components. Further, the server(s) 1004 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they that may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The computer-readable media 1030 can additionally include an operating system 1042 for controlling and managing various functions of the server(s) 1004.

The communication interface(s) 1034 can include one or more interfaces and hardware components for enabling communication with various other devices, such as over the network(s) 1006 or directly. For example, communication interface(s) 1034 can enable communication through one or more network(s) 1006, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 1002 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 1004 can further be equipped with various I/O devices 1032. Such I/O devices 1032 can include a display, various user interface controls (e.g., buttons, joystick, keyboard, mouse, touch screen, biometric or sensory input devices, etc.), audio speakers, connection ports and so forth.

In at least one example, the system 1000 can include a datastore 1044 that can be configured to store data that is accessible, manageable, and updatable. In some examples, the datastore 1044 can be integrated with the user device 1002 and/or the server(s) 1004. In other examples, as shown in FIG. 10, the datastore 1044 can be located remotely from the server(s) 1004 and can be accessible to the server(s) 1004. The datastore 1044 can comprise multiple databases and/or servers connected locally and/or remotely via the network(s) 1006.

In at least one example, the datastore 1044 can store user profiles, which can include merchant profiles, customer profiles, and so on. In some examples, the datastore(s) 1044 can store user profiles of donors, sponsors, organizers, beneficiaries, and other entities associated with a fundraising event, as described herein. In some examples, such user profiles can be associated with one or more user accounts.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider 712.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

Furthermore, in at least one example, the datastore 1044 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1044 can store additional or alternative types of data as described herein.

Example Clauses

1. A computer-implemented method, comprising: receiving, from a first mobile device of a customer and at a computing device associated with a payment service, a first message (i) specifying a first recipient contact information associated with the computing device, and (ii) including an order for one or more items offered by a merchant, the one or more items indicated in the first message having been selected from an inventory of items offered by the merchant; sending a second message from the computing device to a second mobile device associated with the merchant, the second message (i) specifying a second recipient contact information associated with the second mobile device, and (ii) including the order for the one or more items; receiving, from the second mobile device and at the computing device, a third text message (i) specifying the first recipient phone number, and (ii) including an indication that the one or more items have been ordered; sending a fourth text message from the computing device to the first mobile device, the fourth text message (i) specifying a third recipient phone number associated with the first mobile device, and (ii) including the indication; receiving, from at least one of the first mobile device or the second mobile device and at the computing device, a fifth text message (i) specifying the first recipient phone number, and (ii) including a request to process a payment for the one or more items; and initiating payment processing for the one or more items by the computing device at least partly in response to receiving the fifth text message.

2. The computer-implemented method as clause 1 recites, wherein initiating payment processing comprises sending a request to a mobile carrier associated with the first mobile device to charge an account associated with the first mobile device at the mobile carrier for a cost of the one or more items.

3. The computer-implemented method as clause 2 recites, wherein the computing device comprises a first computing device associated with the payment service, and further comprising sending, from a second computing device associated with the payment service, a request to the mobile carrier to send funds for at least a portion of the cost of the one or more items to a financial account associated with the merchant.

4. A system comprising: one or more processors; and non-transitory computer-readable media storing instructions that, when executed by the one or more processors, cause the system to perform operations comprising: receiving, from a first device of a customer, a first electronic message directed to a first identifier associated with the system, the first electronic message comprising an order for one or more items offered by a merchant; sending a second electronic message directed to a second identifier associated with a second device associated with the merchant, the second electronic message comprising the order for the one or more items; receiving, from at least one of the first device or the second device, a third electronic message directed to the first identifier, the third electronic message comprising a request to process a payment for the one or more items; and initiating payment processing for the one or more items at least partly in response to receiving the third electronic message.

5. The system as clause 4 recites, the operations further comprising: receiving, from the first device and prior to the receiving of the third electronic message, a fourth electronic message directed to the first identifier, the fourth electronic message modifying the order for the one or more items; and wherein the initiating comprises initiating the payment processing for the order as modified.

6. The system as clause 4 recites, wherein: the first identifier associated with the system comprises at least one of a first phone number or a first simple messaging service (SMS) short code; and the second identifier associated with the second device comprises at least one of a second phone number or a second SMS short code.

7. The system as clause 6 recites, the operations further comprising: storing an association between: (i) the at least one of the first phone number or the first SMS short code, and (ii) an account of the merchant; receiving, prior to receiving the first electronic message, a request to associate: (i) the at least one of the second phone number or the second SMS short code, and (ii) the account of the merchant; and storing an association between: (i) the at least one of the second phone number or the second SMS short code, and (ii) the account of the merchant.

8. The system as clause 6 recites, the operations further comprising: storing an association between: (i) the at least one of the first phone number or the first SMS short code, and (ii) an account of the merchant; determining, from the account of the merchant that a first employee associated with the at least one of the second phone number or the second SMS short code is scheduled to work at the merchant at a specified time; storing, at the specified time, an association between: (i) the at least one of the second phone number or the second SMS short code, and (ii) the account of the merchant.

9. The system as clause 4 recites, the operations further comprising: storing an association between the first identifier and an account of the merchant; identifying, at least partly in response to receiving the first electronic message directed to the first identifier, the account of the merchant.

10. The system as clause 4 recites, the operations further comprising: receiving, from the first device and prior to receiving the first electronic message, a fourth electronic message directed to the first identifier associated with the system; and sending, to a third identifier associated with the first device, a menu of available items offered by the merchant.

11. The system as clause 4 recites, the operations further comprising: receiving, from the second device and prior to receiving the third electronic message, a fourth electronic message directed to the first identifier, the fourth electronic message comprising an indication that the one or more items have been ordered; sending a fifth electronic message directed to a third identifier associated with the first device, the fifth electronic message comprising the indication that the one or more items have been ordered.

12. The system as clause 4 recites, wherein initiating payment processing comprises sending a request to a mobile carrier associated with the first device to charge an account associated with the first device at the mobile carrier for a cost of the one or more items.

13. The system as clause 12 recites, the operations further comprising sending a request to the mobile carrier to send funds for at least a portion of the cost of the one or more items to a financial account associated with the merchant.

14. A method implemented at least in part by a computing device associated with a payment service, the method comprising: receiving, from a first device of a customer, a first electronic message directed to a first identifier associated with the system, the first electronic message comprising an order for one or more items offered by a merchant; sending a second electronic message directed to a second identifier associated with a second device associated with the merchant, the second electronic message comprising the order for the one or more items; receiving, from at least one of the first device or the second device, a third electronic message directed to the first identifier, the third electronic message comprising a request to process a payment for the one or more items; and initiating payment processing for the one or more items at least partly in response to receiving the third electronic message.

15. The method as clause 14 recites, wherein: the first identifier associated with the system comprises at least one of a first phone number or a first simple messaging service (SMS) short code; and the second identifier associated with the second device comprises at least one of a second phone number or a second SMS short code.

16. The method as clause 15 recites, further comprising: storing an association between: (i) the at least one of the first phone number or the first SMS short code, and (ii) an account of the merchant;

receiving, prior to receiving the first electronic message, a request to associate: (i) the at least one of the second phone number or the second SMS short code, and (ii) the account of the merchant; and storing an association between: (i) the at least one of the second phone number or the second SMS short code, and (ii) the account of the merchant.

17. The method as clause 15 recites, further comprising: storing an association between: (i) the at least one of the first phone number or the first SMS short code, and (ii) an account of the merchant; determining, from the account of the merchant that a first employee associated with the at least one of the second phone number or the second SMS short code is scheduled to work at the merchant at a specified time; storing, at the specified time, an association between: (i) the at least one of the second phone number or the second SMS short code, and (ii) the account of the merchant.

18. The method as clause 14 recites, further comprising: storing an association between the first identifier and an account of the merchant; identifying, at least partly in response to receiving the first electronic message directed to the first identifier, the account of the merchant.

19. The method as clause 14 recites, further comprising: receiving, from the first device and prior to receiving the first electronic message, a fourth electronic message directed to the first identifier associated with the system; and sending, to a third identifier associated with the first device, a menu of available items offered by the merchant.

20. The method as clause 14 recites, wherein initiating payment processing comprises sending a request to a mobile carrier associated with the first device to charge an account associated with the first device at the mobile carrier for a cost of the one or more items, and the method further comprising sending a request to the mobile carrier to send funds for at least a portion of the cost of the one or more items to a financial account associated with the merchant.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to FIGS. 3A-4C for convenience and ease of understanding. However, the methods illustrated are not limited to being performed using components described in FIGS. 1-2E and 5-9, and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

The foregoing is merely illustrative of the principles of this disclosure and various modifications can be made by those skilled in the art without departing from the scope of this disclosure. The above described examples are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process limitations (e.g., dimensions, configurations, components, process step order, etc.) can be made to further optimize the provided structures, devices and methods, as shown and described herein. In any event, the structures and devices, as well as the associated methods, described herein have many applications. Therefore, the disclosed subject matter should not be limited to any single example described herein, but rather should be construed in breadth and scope in accordance with the appended claims.

What is claimed is:

1. A computer-implemented method, comprising:
receiving, from a first mobile device of a customer and at a computing device associated with a payment service, a first message (i) specifying a first recipient contact information associated with the computing device, and (ii) including an order for one or more items offered by a merchant, the one or more items indicated in the first message having been selected from an inventory of items offered by the merchant;
sending a second message from the computing device to a second mobile device associated with the merchant, the second message (i) specifying a second recipient contact information associated with the second mobile device, and (ii) including the order for the one or more items;
receiving, from the second mobile device and at the computing device, a third text message (i) specifying the first recipient phone number, and (ii) including an indication that the one or more items have been ordered;
sending a fourth text message from the computing device to the first mobile device, the fourth text message (i) specifying a third recipient phone number associated with the first mobile device, and (ii) including the indication;
receiving, from at least one of the first mobile device or the second mobile device and at the computing device, a fifth text message (i) specifying the first recipient phone number, and (ii) including a request to process a payment for the one or more items; and
initiating payment processing for the one or more items by the computing device at least partly in response to receiving the fifth text message.

2. The computer-implemented method as claim 1 recites, wherein initiating payment processing comprises sending a request to a mobile carrier associated with the first mobile device to charge an account associated with the first mobile device at the mobile carrier for a cost of the one or more items.

3. The computer-implemented method as claim 2 recites, wherein the computing device comprises a first computing device associated with the payment service, and further comprising sending, from a second computing device associated with the payment service, a request to the mobile carrier to send funds for at least a portion of the cost of the one or more items to a financial account associated with the merchant.

4. A system comprising:
one or more processors; and
non-transitory computer-readable media storing instructions that, when executed by the one or more processors, cause the system to perform operations comprising:
receiving, from a first device of a customer, a first electronic message directed to a first identifier associated with the system, the first electronic message comprising an order for one or more items offered by a merchant;
sending a second electronic message directed to a second identifier associated with a second device associated with the merchant, the second electronic message comprising the order for the one or more items;
receiving, from at least one of the first device or the second device, a third electronic message directed to the first identifier, the third electronic message comprising a request to process a payment for the one or more items; and
initiating payment processing for the one or more items at least partly in response to receiving the third electronic message.

5. The system as claim 4 recites, the operations further comprising:
receiving, from the first device and prior to the receiving of the third electronic message, a fourth electronic message directed to the first identifier, the fourth electronic message modifying the order for the one or more items;
and wherein the initiating comprises initiating the payment processing for the order as modified.

6. The system as claim 4 recites, wherein:
the first identifier associated with the system comprises at least one of a first phone number or a first simple messaging service (SMS) short code; and
the second identifier associated with the second device comprises at least one of a second phone number or a second SMS short code.

7. The system as claim 6 recites, the operations further comprising:
storing an association between: (i) the at least one of the first phone number or the first SMS short code, and (ii) an account of the merchant;
receiving, prior to receiving the first electronic message, a request to associate: (i) the at least one of the second phone number or the second SMS short code, and (ii) the account of the merchant; and
storing an association between: (i) the at least one of the second phone number or the second SMS short code, and (ii) the account of the merchant.

8. The system as claim 6 recites, the operations further comprising:
storing an association between: (i) the at least one of the first phone number or the first SMS short code, and (ii) an account of the merchant;
determining, from the account of the merchant that a first employee associated with the at least one of the second phone number or the second SMS short code is scheduled to work at the merchant at a specified time;
storing, at the specified time, an association between: (i) the at least one of the second phone number or the second SMS short code, and (ii) the account of the merchant.

9. The system as claim 4 recites, the operations further comprising:
storing an association between the first identifier and an account of the merchant;
identifying, at least partly in response to receiving the first electronic message directed to the first identifier, the account of the merchant.

10. The system as claim 4 recites, the operations further comprising:
receiving, from the first device and prior to receiving the first electronic message, a fourth electronic message directed to the first identifier associated with the system; and
sending, to a third identifier associated with the first device, a menu of available items offered by the merchant.

11. The system as claim 4 recites, the operations further comprising:
receiving, from the second device and prior to receiving the third electronic message, a fourth electronic message directed to the first identifier, the fourth electronic message comprising an indication that the one or more items have been ordered;
sending a fifth electronic message directed to a third identifier associated with the first device, the fifth electronic message comprising the indication that the one or more items have been ordered.

12. The system as claim 4 recites, wherein initiating payment processing comprises sending a request to a mobile carrier associated with the first device to charge an account associated with the first device at the mobile carrier for a cost of the one or more items.

13. The system as claim 12 recites, the operations further comprising sending a request to the mobile carrier to send funds for at least a portion of the cost of the one or more items to a financial account associated with the merchant.

14. A method implemented at least in part by a computing device associated with a payment service, the method comprising:
receiving, from a first device of a customer, a first electronic message directed to a first identifier associated with the system, the first electronic message comprising an order for one or more items offered by a merchant;
sending a second electronic message directed to a second identifier associated with a second device associated with the merchant, the second electronic message comprising the order for the one or more items;
receiving, from at least one of the first device or the second device, a third electronic message directed to the first identifier, the third electronic message comprising a request to process a payment for the one or more items; and
initiating payment processing for the one or more items at least partly in response to receiving the third electronic message.

15. The method as claim 14 recites, wherein:
the first identifier associated with the system comprises at least one of a first phone number or a first simple messaging service (SMS) short code; and
the second identifier associated with the second device comprises at least one of a second phone number or a second SMS short code.

16. The method as claim 15 recites, further comprising:
storing an association between: (i) the at least one of the first phone number or the first SMS short code, and (ii) an account of the merchant;
receiving, prior to receiving the first electronic message, a request to associate: (i) the at least one of the second phone number or the second SMS short code, and (ii) the account of the merchant; and
storing an association between: (i) the at least one of the second phone number or the second SMS short code, and (ii) the account of the merchant.

17. The method as claim 15 recites, further comprising:
storing an association between: (i) the at least one of the first phone number or the first SMS short code, and (ii) an account of the merchant;
determining, from the account of the merchant that a first employee associated with the at least one of the second phone number or the second SMS short code is scheduled to work at the merchant at a specified time;
storing, at the specified time, an association between: (i) the at least one of the second phone number or the second SMS short code, and (ii) the account of the merchant.

18. The method as claim 14 recites, further comprising:
storing an association between the first identifier and an account of the merchant;
identifying, at least partly in response to receiving the first electronic message directed to the first identifier, the account of the merchant.

19. The method as claim 14 recites, further comprising:
receiving, from the first device and prior to receiving the first electronic message, a fourth electronic message directed to the first identifier associated with the system; and
sending, to a third identifier associated with the first device, a menu of available items offered by the merchant.

20. The method as claim 14 recites, wherein initiating payment processing comprises sending a request to a mobile carrier associated with the first device to charge an account associated with the first device at the mobile carrier for a cost of the one or more items, and the method further comprising sending a request to the mobile carrier to send funds for at least a portion of the cost of the one or more items to a financial account associated with the merchant.
